(19) United States
(12) Patent Application Publication
(10) Pub. No.: US 2008/0299329 A1
(43) Pub. Date: Dec. 4, 2008

(54) CYCLIC OLEFIN POLYMER, OPTICAL MATERIAL, POLARIZING PLATE AND LIQUID CRYSTAL DISPLAY

(75) Inventor: Saisuke WATANABE, Minami-Ashigara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/110,420

(22) Filed: Apr. 28, 2008

(30) Foreign Application Priority Data
Apr. 27, 2007 (JP) 2007-119850
Mar. 31, 2008 (JP) 2008-094238

(51) Int. Cl. G02B 1/08; C08F 132/08

(52) U.S. Cl. 428/1.31; 526/281

(57) ABSTRACT

A cyclic olefin polymer is provided and includes a repeating unit represented by formula (1A) and a repeating unit represented by the formula (1B):

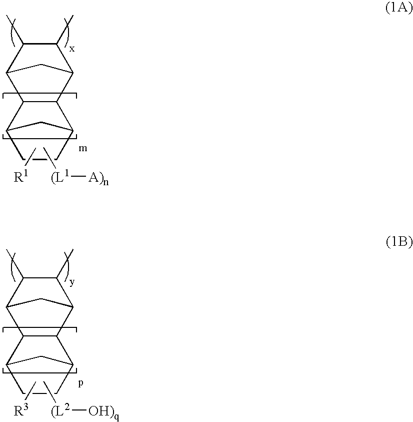

R¹ and R³ each independently represents a substituent, L¹ and L² each independently represents a single bond or a divalent linking group, m and p each independently represents an integer of 0 or 1, and n and q each independently represents an integer of 1 to 4; and A represents COOR² or OCOR², and R² represents a linear alkyl group having a carbon number of 1 to 10. The cyclic olefin polymer has a copolymerization ratio of x and y satisfying 0.03≦y/(x+y)≦0.50, a number average molecular weight of from 70,000 to 300,000, and a weight average molecular weight of from 200,000 to 700,000.

This application is based on and claims priority under 35 U.S.C §119 from Japanese Patent Application Nos. JP2007-119850 and JP2008-094238, filed on Apr. 27, 2007 and Mar. 31, 2008, respectively, the entire disclosure of which is herein incorporated by reference.

### BACKGROUND OF THE INVENTION

1. Field of the Invention

The present invention relates to a cyclic olefin polymer applicable to a cold-casting film-forming method, and an optical material, a polarizing plate and a liquid crystal display each using the same.

2. Description of Related Art

In recent years, a cellulose acylate film and a cyclic olefin polymer film are mainly used as the film for a liquid crystal display. The cost of such a film is dependent not only on the cost of the material itself but also on the productivity of the film production (film-forming) method.

As regards the film-forming method for the cellulose acylate film, a cold-casting film-forming method is commonly used (see, JP-A-2004-98512). This method is a method where a high-concentration solution of cellulose acylate is cast and almost without drying it, immediately cooled, thereby imparting a self-supporting property to the film, and the film is separated from the die and dried. In this method, both surfaces are dried from the initial stage of the drying and therefore, drying of the film is attained very rapidly. Accordingly, high-speed film formation at a rate of a hundred and several tens of meters per minute can be realized. That is, the productivity of the film is excellent.

On the other hand, the method for film-forming a cyclic olefin polymer, particularly, a cyclic olefin polymer including only hydrocarbon, is typified by a melt film-forming method (see, Japanese Patent No. 3846567). In this method, the film-forming speed is as low as about several tens of meters per minute and the productivity is very poor as compared with the above-described high-speed film formation. In the case of a cyclic olefin polymer having a polar group, there is known a technique of producing the film by a solution film-forming method, but a film-forming method enabling the high-speed film formation is not described (see, JP-A-2001-354755 and WO 04/049011).

The requirement in applying the cold-casting film-forming method is supposed to be that the polymer solution (dope) is gelled (solidified) when cooled. The cold-gelling ability (the ability of gelling in cooling) is a property found only in specific polymers and therefore, the application to a cold-casting film-forming method is less known. In particular, the application of a cyclic olefin polymer is not known at all. The cyclic olefin polymer in general as described in JP-A-2001-354755 and WO 04/049011 does not have a cold-gelling ability and is difficult of high-speed film formation.

### SUMMARY OF THE INVENTION

An object of an illustrative, non-limiting embodiment of the present invention is to provide a cyclic olefin polymer applicable to a cold-casting film-forming method.

The present inventors have made studies with an attempt to endow a cold-gelling ability to a cyclic olefin polymer and taken notice of a cyclic olefin polymer where a hydroxyl group is introduced to form a network among polymers having a sufficiently high molecular weight. As a result, it has been found that when an ester group or acyl group and a hydroxyl group are appropriately caused to be present together in a polymer at a certain ratio, even a cyclic olefin polymer can have a cold-gelling ability. That is, the above-described object can be attained by the following means.

(1) A cyclic olefin polymer including a repeating unit represented by formula (1A) and a repeating unit represented by the formula (1B):

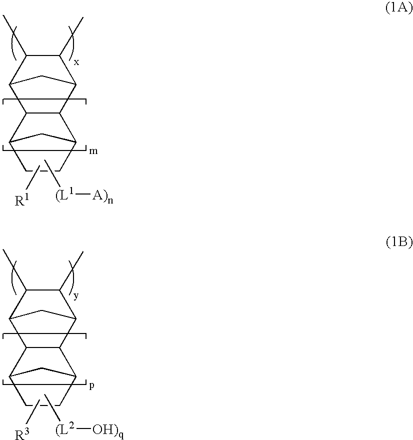

wherein R¹ and R³ each independently represents a substituent, L¹ and L² each independently represents a single bond or a divalent linking group, m and p each independently represents an integer of 0 or 1, and n and q each independently represents an integer of 1 to 4; and A represents COOR² or OCOR², and R² represents a linear alkyl group having a carbon number of 1 to 10,

wherein the cyclic olefin polymer has a copolymerization ratio of x and y satisfying 0.03≦y/(x+y)≦0.50, a number average molecular weight of from 70,000 to 300,000, and a weight average molecular weight of from 200,000 to 700,000.

(2) The cyclic olefin polymer according to (1), wherein A is OCOR².
(3) The cyclic olefin polymer according to (1) or (2), further including a repeating unit represented by formula (2):

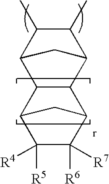

wherein R⁴, R⁵, R⁶ and R⁷ each independently represents a hydrogen atom, a halogen atom, an alkyl group having a carbon number of 1 to 10, an aryl group having a carbon number of 6 to 20, an alkoxy group having a carbon number of 1 to 10, an acyl group having a carbon number of 1 to 10, or a carboxyl group, and r represents an integer of 0 or 1.
(4) The cyclic olefin polymer according to (2) or (3), wherein each of n and q is 1, and a total endo ratio of substituents L¹-A and L²-OH is from 50 to 100%.
(5) An optical material formed from a cyclic olefin polymer according to any one of (1) to (4).
(6) The optical material according to (5), wherein the optical material is a thin-layer, a film or a sheet.
(7) The optical material according to (6), which satisfying conditions:

0≦Re≦100 nm

0≦Rth≦400 nm

wherein Re and Rth represent an in-plane retardation and a retardation in a thickness direction at a wavelength of 590 nm, respectively.
(8) A polarizing plate comprising: a polarizer and two protective films disposed on the respective sides of the polarizer, wherein at least one of the two protective films is an optical material according to (7).
(9) A liquid crystal display comprising a polarizing plate according to (8).

### BRIEF DESCRIPTION OF THE DRAWINGS

The features of the invention will appear more fully upon consideration of the exemplary embodiments of the inventions, which are schematically set forth in the drawings, in which:

FIG. 1 is a schematic view of a film-forming line used in a solution film-forming method according to an exemplary embodiment of the present invention;

FIG. 2 is an enlarged schematic view of main parts of the film-forming line shown in FIG. 1; and

FIG. 3 is an enlarged schematic view of main parts of the film-forming line shown in FIG. 1,

wherein reference numerals and signs in the drawings are set forth below.
10 Film-forming line
11 Mixing tank
12 Dope
13 Stirring blade
14 Pump
15 Filtering device
19 Drying air
20 Casting chamber
21 Casting die
22 Rotating drum
22a Landing line
22b Stripping line
22c Gel film-free plane
23 Cast bead
23b Cast bead back surface
24 Gel film
25 Stripping roller
26 Film
27 Gas supply device
27a Gas pipeline
28, 30, 48, 49 Gas
29 Air blower
31 Recovery device
31a Condensing plane
32 Thermometer
40, 41 Support-rotating shaft
42, 43 Shaft bearing
44 Coolant
45 Coolant supply device
60 Tenter chamber
61 Drying chamber
62 Dryer
63 Roller
64 Cooling chamber
65 Take-up machine
C1 Clearance

### DETAILED DESCRIPTION OF THE EXEMPLARY EMBODIMENTS

A cyclic olefin polymer according to an exemplary embodiment of the present invention, where the molecular weight is sufficiently elevated and an ester group or acyl group and a hydroxyl group are caused to be present together at a specific ratio, can have a cold-gelling ability and is applicable to a cold-casting film-forming method, yielding very good productivity. The polarizing plate using, as a protective film, an optical film comprising the cyclic olefin polymer of the present invention is assured of excellent contact with a polarizer and exhibits good adhesion at the processing. Furthermore, a liquid crystal display using the polarizing plate can provide an excellent image.

Exemplary embodiments of the present invention are described in detail below.

### (Structure of Polymer)

### (Structure)

A polymer of the present invention is a cyclic olefin polymer including at least a repeating unit represented by the following formula (1A) and a repeating unit represented by the following formula (1B), wherein the number average molecular weight is from 70,000 to 200,000 and the weight average molecular weight is from 200,000 to 700,000 and wherein the copolymerization ratio of x and y between the repeating unit represented by the following formula (1A) and the repeating unit represented by the following formula (1B) satisfies 0.03≦y/(x+y)≦0.50.

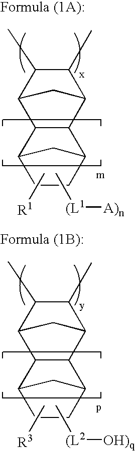

In formulae (1A) and (1B), R¹ and R³ each independently represents a substituent, A represents COOR² or OCOR², R² represents a linear alkyl group having a carbon number of 1 to 10, L¹ and L² each independently represents a single bond or a divalent linking group, m and p each independently represents an integer of 0 or 1, and n and q each independently represents an integer of 1 to 4.

The polymer of the present invention has an OH group and therefore, when dissolved in an appropriate solvent, the polymers form a hydrogen bond with each other, whereby a gel can be formed. On the other hand, if the other side chain A of the polymer is not an ester or acyl group, the dope does not become transparent and a transparent film cannot be obtained. In order to satisfy these conditions at the same time, the above-described range of y/(x+y) must be satisfied.

The repeating unit represented by the following formula (1A) is described in detail below.

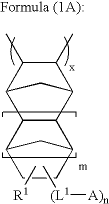

The repeating unit represented by formula (1A) can be formed by the addition polymerization of a cyclic olefin represented by the following formula (3):

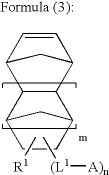

In formula (3), R¹, L¹, A, m and n have the same meanings as those in formula (1A).

R¹ represents a hydrogen atom or a substituent, and as for preferred examples of the substituent, those described later as examples of the substituent R³ in formula (4) may be applied.

A represents COOR² or OCOR², and R² is a linear alkyl group having a carbon number of 1 to 10, preferably a linear alkyl group having a carbon number of 1 to 6, more preferably a linear alkyl group having a carbon number of 1 to 4, and most preferably a methyl group, an ethyl group or a butyl group. If R² is a branched group, deterioration of the film readily occur due to hydrolysis, and the polymer is not preferred as a material for film. The preferred ranges of L¹, m and n are the same as the preferred ranges of L², p and q in formula (4) described later.

In formula (1A), A is preferably represented by OCOR². That is, formula (1A) is preferably represented by the following formula (1C). The cyclic olefin polymer comprising respective repeating units of formula (1A) and formula (1B) can be obtained by the hydrolysis or solvolysis of a cyclic olefin polymer containing a repeating unit represented by the following formula (1C).

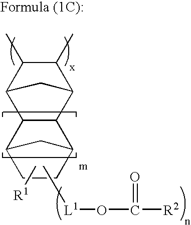

The repeating unit represented by formula (1C) can be formed by the addition polymerization of a cyclic olefin represented by the following formula (5):

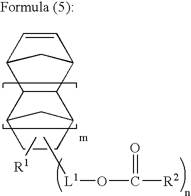

In formula (5), R¹, L¹, R², m and n have the same meanings as those in formula (1A).

R¹ represents a hydrogen atom or a substituent and as for preferred examples of the substituent, those described later as examples of the substituent R³ in formula (4) may be applied.

R² is a linear alkyl group having a carbon number of 1 to 10, preferably a linear alkyl group having a carbon number of 1 to 6, more preferably a linear alkyl group having a carbon number of 1 to 4, and most preferably a methyl group, an ethyl group or a butyl group.

The preferred ranges of L¹, m and n are the same as the preferred ranges of L², p and q in formula (4) described later.

The repeating unit represented by formula (1B) is described below.

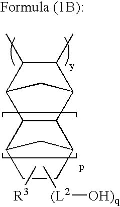

In formula (1B), R³, L², p, q and y have the same meanings as those in formula (1).

The repeating unit represented by formula (1B) can be formed by the addition polymerization of a cyclic olefin represented by the following formula (4).

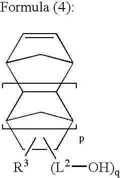

In formula (4), R³, L², p and q have the same meanings as those in formula (1B).

R³ represents a hydrogen atom or a substituent, and the substituent is preferably a halogen atom (e.g., fluorine, chlorine, bromine, iodine), an alkyl group (preferably an alkyl group having a carbon number of 1 to 30, e.g., methyl, ethyl, n-propyl, isopropyl, tert-butyl, n-octyl, 2-ethylhexyl), a cycloalkyl group (preferably a substituted or unsubstituted cycloalkyl group having a carbon number of 3 to 30, e.g., cyclohexyl, cyclopentyl, 4-n-dodecylcyclohexyl), a bicycloalkyl group (preferably a substituted or unsubstituted bicycloalkyl group having a carbon number of 5 to 30, that is, a monovalent group obtained by removing one hydrogen atom from a bicycloalkane having a carbon number of 5 to 30; e.g., bicyclo[1,2,2]heptan-2-yl, bicyclo[2,2,2]octan-3-yl),

an alkenyl group (preferably a substituted or unsubstituted alkenyl group having a carbon number of 2 to 30, e.g., vinyl, allyl), a cycloalkenyl group (preferably a substituted or unsubstituted cycloalkenyl group having a carbon number of 3 to 30, that is, a monovalent group obtained by removing one hydrogen atom from a cycloalkane having a carbon number of 3 to 30; e.g., 2-cyclopenten-1-yl, 2-cyclohexen-1-yl), a bicycloalkenyl group (a substituted or unsubstituted bicycloalkenyl group, preferably a substituted or unsubstituted bicycloalkenyl group having a carbon number of 5 to 30, that is, a monovalent group obtained by removing one hydrogen atom from a bicycloalkane having one double bond; e.g., bicyclo[2,2,1]hept-2-en-1-yl, bicyclo[2,2,2]oct-2-en-4-yl), an alkynyl group (preferably a substituted or unsubstituted alkynyl group having a carbon number of 2 to 30, e.g., ethynyl, propargyl), an aryl group (preferably a substituted or unsubstituted aryl group having a carbon number of 6 to 30, e.g., phenyl, p-tolyl, naphthyl), a heterocyclic group (preferably a monovalent group obtained by removing one hydrogen atom from a 5- or 6-membered substituted or unsubstituted, aromatic or non-aromatic heterocyclic compound, more preferably a 5- or 6-membered aromatic heterocyclic group having a carbon number of 3 to 30; e.g., 2-furyl, 2-thienyl, 2-pyrimidinyl, 2-benzothiazolyl), a cyano group, a hydroxyl group, a nitro group, a carboxyl group, an alkoxy group (preferably a substituted or unsubstituted alkoxy group having a carbon number of 1 to 30, e.g., methoxy, ethoxy, isopropoxy, tert-butoxy, n-octyloxy, 2-methoxyethoxy), an aryloxy group (preferably a substituted or unsubstituted aryloxy group having a carbon number of 6 to 30, e.g., phenoxy, 2-methylphenoxy, 4-tert-butylphenoxy, 3-nitrophenoxy, 2-tetradecanoylaminophenoxy), a silyloxy group (preferably a silyloxy group having a carbon number of 3 to 20, e.g., trimethylsilyloxy, tert-butyldimethylsilyloxy), a heterocyclic oxy group (preferably a substituted or unsubstituted heterocyclic oxy group having a carbon number of 2 to 30, e.g., 1-phenyltetrazol-5-oxy, 2-tetrahydropyranyloxy), an acyloxy group (preferably a formyloxy group, a substituted or unsubstituted alkylcarbonyloxy group having a carbon number of 2 to 30, or a substituted or unsubstituted arylcarbonyloxy group having a carbon number of 6 to 30, e.g., formyloxy, acetyloxy, pivaloyloxy, stearoyloxy, benzoyloxy, p-methoxyphenylcarbonyloxy), a carbmoyloxy group (preferably a substituted or unsubstituted carbamoyloxy group having a carbon umber of 1 to 30, e.g., N,N-dimethylcarbmoyloxy, N,N-diethylcarbamoyloxy, morpholinocarbonyloxy, N,N-di-n-octylaminocarbonyloxy, N-n-octylcarbamoyloxy), an alkoxycarbonyloxy group (preferably a substituted or unsubstituted alkoxycarbonyloxy group having a carbon number of 2 to 30, e.g., methoxycarbonyloxy, ethoxycarbonyloxy, tert-butoxycarbonyloxy, n-octylcarbonyloxy), an aryloxycarbonyloxy group (preferably a substituted or unsubstituted aryloxycarbonyloxy group having a carbon number of 7 to 30, e.g., phenoxycarbonyloxy, p-methoxyphenoxycarbonyloxy, p-n-hexadecyloxyphenoxycarbonyloxy),

an amino group (preferably an amino group, a substituted or unsubstituted alkylamino group having a carbon number of 1 to 30, or a substituted or unsubstituted anilino group having a carbon number of 6 to 30, e.g., amino, methylamino, dimethylamino, anilino, N-methyl-anilino, diphenylamino), an acylamino group (preferably a formylamino group, a substituted or unsubstituted alkylcarbonylamino group having a carbon number of 1 to 30, or a substituted or unsubstituted arylcarbonylamino group having a carbon number of 6 to 30, e.g., formylamino, acetylamino, pivaloylamino, lauroylamino, benzoylamino), an aminocarbonylamino group (preferably a substituted or unsubstituted aminocarbonylamino group having a carbon number of 1 to 30, e.g., carbamoylamino, N,N-dimethylaminocarbonylamino, N,N-diethylaminocarbonylamino, morpholinocarbonylamino), an alkoxycarbonylamino group (preferably a substituted or unsubstituted alkoxy-carbonylamino group having a carbon number of 2 to 30, e.g., methoxycarbonylamino, ethoxycarbonylamino, tert-butoxycarbonylamino, n-octadecyloxycarbonylamino, N-methyl-methoxycarbonylamino), an aryloxycarbonylamino group (preferably a substituted or unsubstituted aryloxycarbonylamino group having a carbon number of 7 to 30, e.g., phenoxycarbonylamino, p-chlorophenoxycarbonylamino, m-n-octyloxyphenoxycarbonylamino), a sulfamoylamino group (preferably a substituted or unsubstituted sulfamoylamino group having a carbon number of 0 to 30, e.g., sulfamoylamino, N,N-dimethylaminosulfonylamino, N-n-octylaminosulfonylamino), an alkyl- or aryl-sulfonylamino group (preferably a substituted or unsubstituted alkylsulfonylamino group having a carbon number of 1 to 30, or a substituted or unsubstituted arylsulfonylamino group having a carbon number of 6 to 30, e.g., methylsulfonylamino, butylsulfonylamino, phenylsulfonylamino, 2,3,5-trichlorophenylsulfonylamino, p-methylphenylsulfonylamino), a mercapto group, an alkylthio group (preferably a substituted or unsubstituted alkylthio group having a carbon number of 1 to 30, e.g., methylthio, ethylthio, n-hexadecylthio), an arylthio group (preferably a substituted or unsubstituted arylthio group having a carbon number of 6 to 30, e.g., phenylthio, p-chlorophenylthio, m-methoxyphenylthio), a heterocyclic thio group (preferably a substituted or unsubstituted heterocyclic thio group having a carbon number of 2 to 30, e.g., 2-benzothiazolylthio, 1-phenyltetrazol-5-ylthio),

a sulfamoyl group (preferably a substituted or unsubstituted sulfamoyl group having a carbon number of 0 to 30, e.g., N-ethylsulfamoyl, N-(3-dodecyloxypropyl)sulfamoyl, N,N-dimethylsulfamoyl, N-acetylsulfamoyl, N-benzoylsulfamoyl, N—(N′-phenylcarbamoyl)sulfamoyl), a sulfo group, an alkyl- or aryl-sulfinyl group (preferably a substituted or unsubstituted alkylsulfinyl group having a carbon number of 1 to 30, or a substituted or unsubstituted arylsulfinyl group having a carbon number of 6 to 30, e.g., methylsulfinyl, ethylsulfinyl, phenylsulfinyl, p-methylphenylsulfinyl), an alkyl- or aryl-sulfonyl group (preferably a substituted or unsubstituted alkylsulfonyl group having a carbon number of 1 to 30, or a substituted or unsubstituted arylsulfonyl group having a carbon number of 6 to 30, e.g., methylsulfonyl, ethylsulfonyl, phenylsulfonyl, p-methylphenylsulfonyl), an acyl group (preferably a formyl group, a substituted or unsubstituted alkylcarbonyl group having a carbon number of 2 to 30, or a substituted or unsubstituted arylcarbonyl group having a carbon number of 7 to 30, e.g., acetyl, pivaloylbenzoyl), an aryloxycarbonyl group (preferably a substituted or unsubstituted aryloxycarbonyl group having a carbon number of 7 to 30, e.g., phenoxycarbonyl, o-chlorophenoxycarbonyl, m-nitrophenoxycarbonyl, p-tert-butylphenoxycarbonyl), an alkoxycarbonyl group (preferably a substituted or unsubstituted alkoxycarbonyl group having a carbon number of 2 to 30, e.g., methoxycarbonyl, ethoxycarbonyl, tert-butoxycarbonyl, n-octadecyloxycarbonyl), a carbamoyl group (preferably a substituted or unsubstituted carbamoyl group having a carbon number of 1 to 30, e.g., carbamoyl, N-methylcarbamoyl, N,N-dimethylcarbamoyl, N,N-di-n-octylcarbamoyl, N-(methylsulfonyl)carbamoyl), an aryl- or heterocyclic-azo group (preferably a substituted or unsubstituted arylazo group having a carbon number of 6 to 30, or a substituted or unsubstituted heterocyclic azo group having a carbon number of 3 to 30, e.g., phenylazo, p-chlorophenylazo, 5-ethylthio-1,3,4-thiadiazol-2-yl azo), an imido group (preferably N-succinimido or N-phthalimido), a phosphino group (preferably a substituted or unsubstituted phosphino group having a carbon number of 2 to 30, e.g., dimethylphosphino, diphenylphosphino, methylphenoxyphosphino), a phosphinyl group (preferably a substituted or unsubstituted phosphinyl group having a carbon number of 2 to 30, e.g., phosphinyl, dioctyloxyphosphinyl, diethoxyphosphinyl), a phosphinyloxy group (preferably a substituted or unsubstituted phosphinyloxy group having a carbon number of 2 to 30, e.g., diphenoxyphosphinyloxy, dioctyloxyphosphinyloxy), a phosphinylamino group (preferably a substituted or unsubstituted phosphinylamino group having a carbon number of 2 to 30, e.g., dimethoxyphosphinylamino, dimethylaminophosphinylamino), or a silyl group (preferably a substituted or unsubstituted silyl group having a carbon number of 3 to 30, e.g., trimethylsilyl, tert-butyldimethylsilyl, phenyldimethylsilyl).

Out of the substituents above, those having a hydrogen atom may be deprived of the hydrogen atom and further be substituted with the above-described group. Examples of such a functional group include an alkylcarbonylaminosulfonyl group, an arylcarbonylaminosulfonyl group, an alkylsulfonylaminocarbonyl group, and an arylsulfonylaminocarbonyl group. Examples thereof include methylsulfonylaminocarbonyl, p-methylphenylsulfonylaminocarbonyl, acetylaminosulfonyl, and benzoylaminosulfonyl.

In the case where two or more substituents are present, the substituents may be the same or different and, if possible, may be linked with each other to form a ring.

R³ is preferably a halogen atom, an alkyl group having a carbon number of 1 to 10, an aryl group having a carbon number of 6 to 10, a cycloalkyl group having a carbon number of 3 to 10, a cyano group, an acyloxy group having a carbon number of 2 to 10, an alkoxycarbonyl group having a carbon number of 2 to 10, or a hydrogen atom.

L² represents a single bond or a divalent linking group, provided that an alcohol is formed by the bonding of L² to OH. The divalent linking group is preferably an alkylene, alkenylene, alkynylene or arylene group which may be substituted, or a group obtained by combining two or more of these divalent groups, and the divalent linking group when composed of a combination of two or more divalent groups may be further linked with another divalent linking group. Examples of such a divalent linking group include a group represented by —NR⁹— (wherein R⁹ represents a hydrogen atom, or an alkyl or aryl group which may have a substituent), —O—, —S—, —SO—, —SO₂—, —CO—, —SO₂NR⁹—, —NR⁹SO₂—, —CONR⁹—, —NR⁹CO—, —COO— and —OCO—. As for the substituent here, examples of the substituent of R³ above can be applied.

L² is preferably a single bond or a group comprising carbon, hydrogen and oxygen, and most preferably a single bond, an alkylene group having a carbon number of 1 to 10, more preferably from 1 to 6, which may be substituted, or —COOC₂H₄—.

p is an integer of 0 or 1, more preferably 0. q is an integer of 1 to 4, more preferably 1 or 2. R³ and L² may combine with each other to form a 5- to 7-membered ring, and the ring is preferably a 5- or 6-membered ring. Also, the ring may be either a carbon ring or a hetero ring but is preferably a carbon ring.

Specific examples of the cyclic olefin represented by formula (4) are set forth below, but the present invention is not limited thereto.

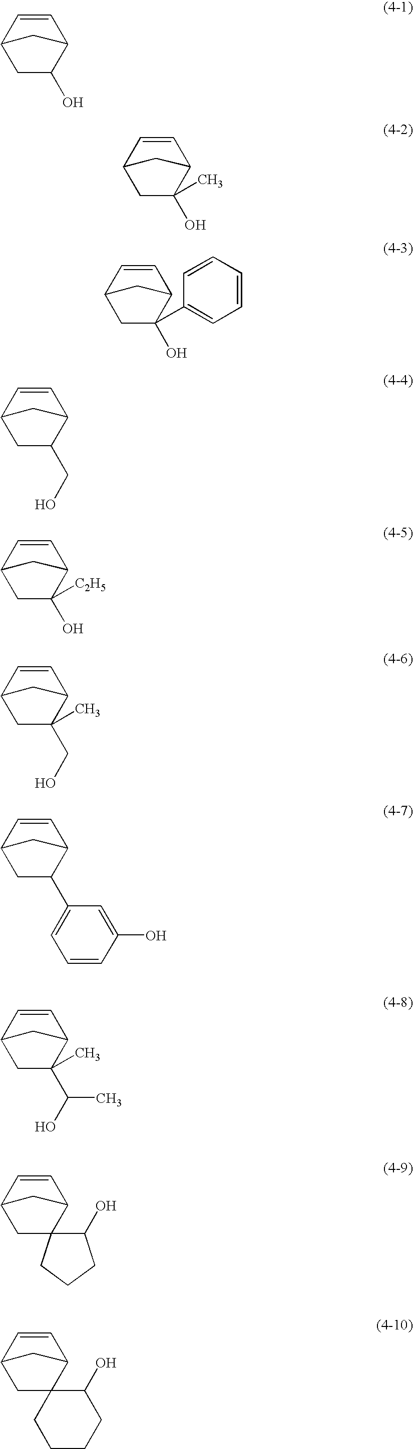

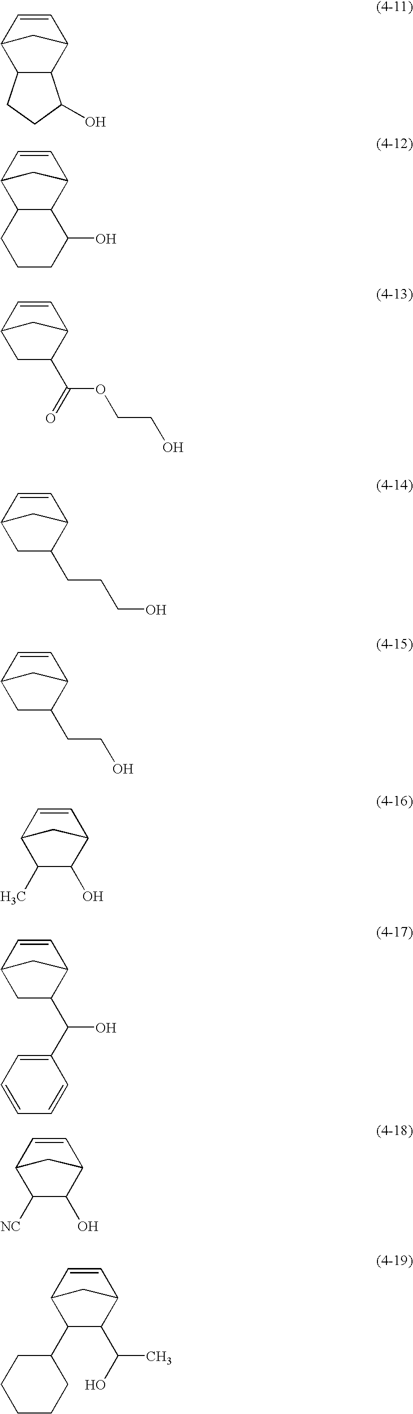

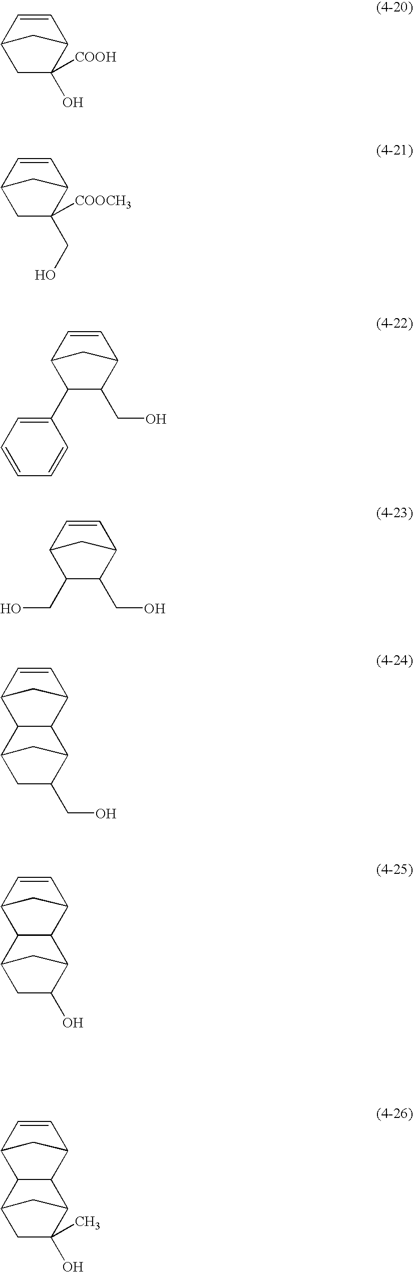

One of the cyclic olefins represented by formula (4) may be used alone, or two or more thereof may be used in combination.

In formula (1B), R³, L¹, p and q have the same meanings as R³, L², p and q in formula (4).

The cyclic olefin polymer of the present invention may comprise only respective repeating units of formula (1A) and formula (1b) but may also contain a repeating unit represented by formula (2). In the case of containing a repeating unit represented by formula (2), the proportion thereof in the polymer is preferably from 1 to 50 mol %.

The repeating unit represented by formula (2) can be introduced using a specific cyclic olefin represented by the following formula (6):

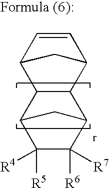

In formula (6), R⁴, R⁵, R⁶, R⁷ and r have the same meanings as those in formula (2).

R⁴, R⁵, R⁶ and R⁷ each independently represents a hydrogen atom, a halogen atom, an alkyl group having a carbon number of 1 to 10, an aryl group having a carbon number of 6 to 20, an alkoxy group having a carbon number of 1 to 10, an acyl group having a carbon number of 1 to 10, or a carboxyl group. If possible, these may combine with each other to form a 5- to 7-membered ring, and the ring is preferably a 5- or 6-membered ring. Also, the ring may be either a carbon ring or a hetero ring. r represents an integer of 0 to 1 and is preferably 0.

Specific examples of the cyclic olefin represented by formula (6) are set forth below, but the present invention is not limited thereto.

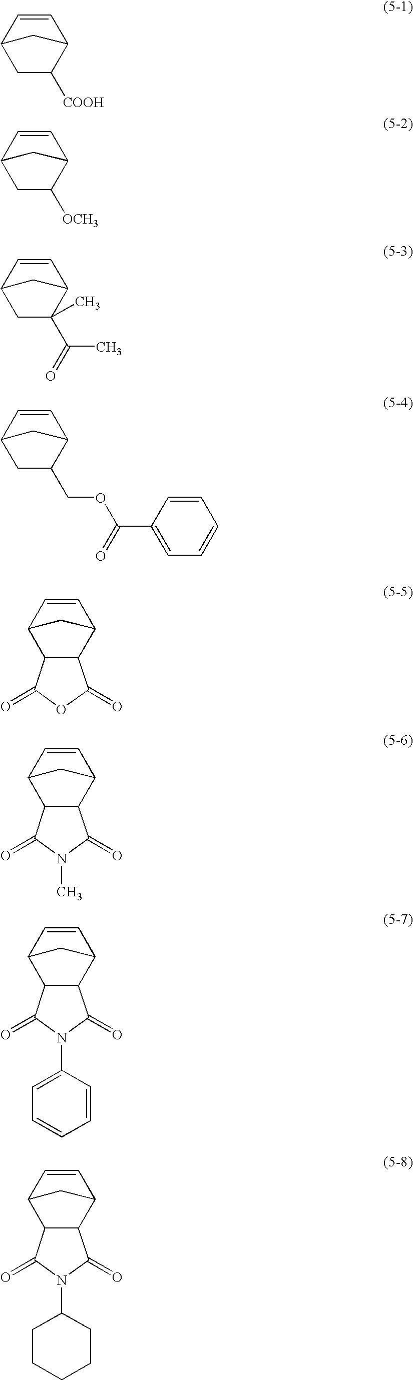

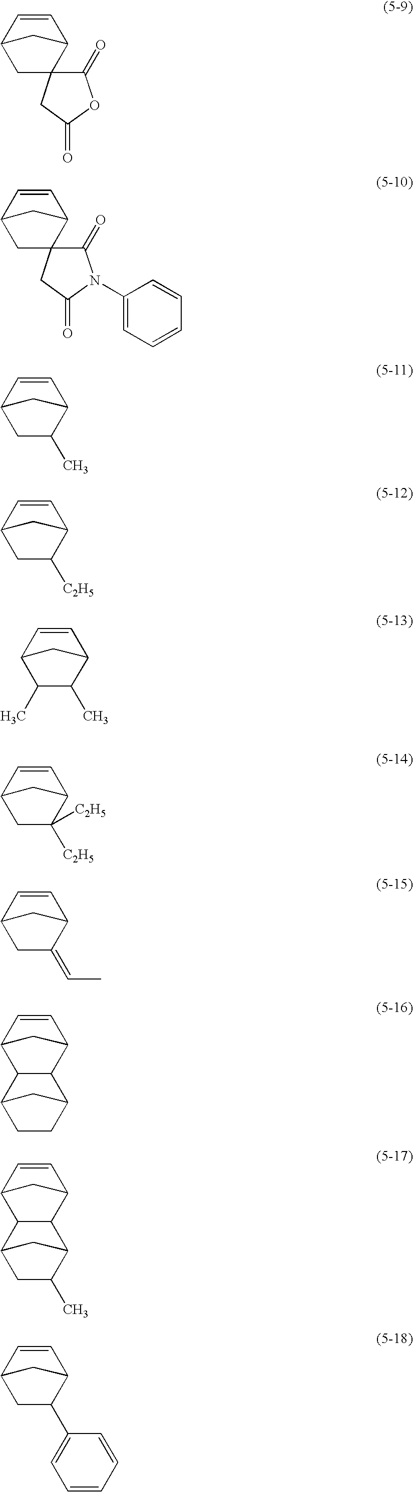

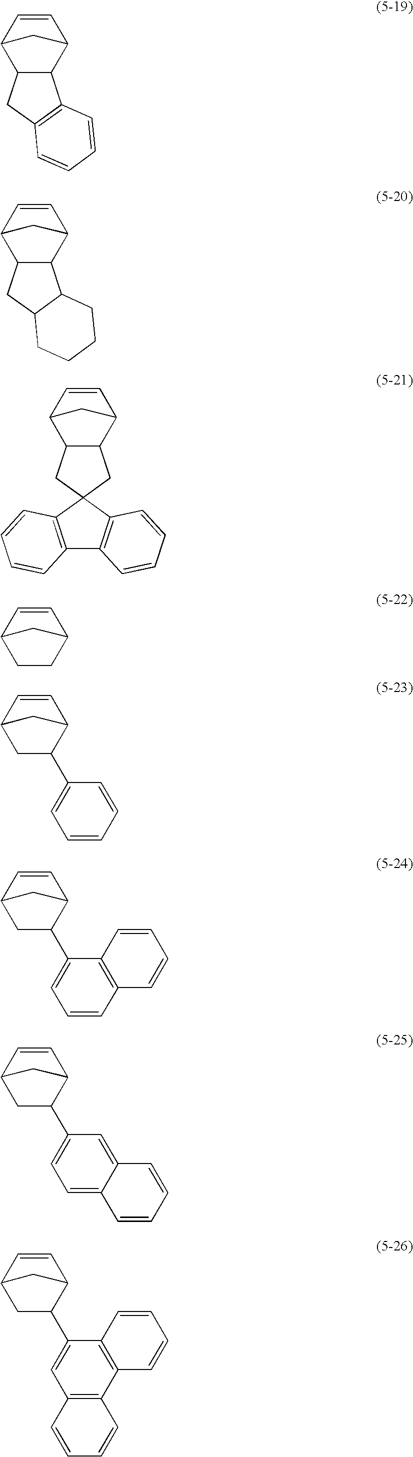

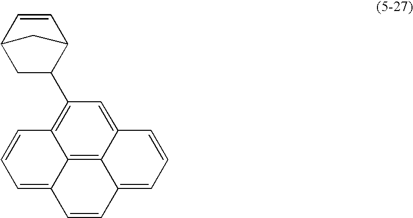

One of the cyclic olefins represented by formula (6) may be used alone, or two or more thereof may be used in combination.

The cyclic olefins for use in the present invention can be synthesized by referring to the method known in publications. Examples of the method include the method described in Bull. Chem. Soc. Jpn., 48, 3641-3644 (1975), and the method described in J. Chem. Soc. Perkin Trans., 2, 17-22 (1974), but the synthesis method of the cyclic olefins for use in the present invention is not limited to these methods.

The cyclic olefin polymer of the present invention having a repeating unit represented by formula (1A) and a repeating unit represented by formula (1b) may also be obtained by polymerizing a monomer represented by formula (5), and hydrolyzing or solvolyzing the polymer. In the case of introducing a repeating unit represented by formula (2) into the polymer, the cyclic olefin polymer may also be obtained by copolymerizing a monomer represented by formula (5) and a monomer represented by formula (6), and hydrolyzing or solvolyzing the copolymer. In general, when a norbornene-based monomer having a hydroxyl group is polymerized, a problem is brought about, for example, the yield is low or the molecular weight does not increase. For this reason, the method of performing hydrolysis or solvolysis is preferably employed.

As for the hydrolysis or solvolysis, a known method such as acid catalyst hydrolysis, base catalyst hydrolysis, alcolysis and aminolysis described, for example, in T. W. GREENE and R. G. M. WUTS, PROTECTIVE GROUPS IN ORGANIC SYNTHESIS SECOND EDITION, pp. 87-113, JOHN WILEY & SONS, Inc. (1991) may be applied. In the base catalyst hydrolysis, for example, the polymer is dissolved in a hydrophilic solvent (e.g., tetrahydrofuran), a basic aqueous solution (e.g., aqueous sodium hydroxide solution) is added thereto, and the mixture is stirred under heating, whereby the acyl group can be partially converted into a hydroxyl group. The conversion ratio into the hydroxyl group can be appropriately adjusted by the reaction time, the amount of base, the amount of water, or the like. On the other hand, a method of effecting the solvolysis by dissolving the polymer in a soluble solvent and an alcohol and adding a catalyst to the solution is simple and easy. For example, the cyclic olefin polymer is dissolved in a mixed solvent of methylene chloride and methanol and reacted by using a metallic alkoxide such as sodium methoxide and after the passing of an appropriate time, a quenching agent such as acetic acid is added to stop the reaction, whereby the acyl group can be partially converted into a hydroxyl group. The conversion ratio into the hydroxyl group can be appropriately adjusted by the reaction time, the amount of alcohol, the amount of catalyst, or the like.

The polymer of the present invention can also be obtained by the following method.

A specific olefin compound is (co)polymerized at a temperature of −20 to 100° C. in a solvent selected from an alicyclic hydrocarbon solvent such as cyclohexane, cyclopentane and methylcyclopentane, an aliphatic hydrocarbon solvent such as pentane, hexane, heptane and octane, an aromatic hydrocarbon solvent such as toluene, benzene and xylene, a halogenated hydrocarbon solvent such as dichloromethane, 1,2-dichloroethylene and chlorobenzene, and a polar solvent such as ethyl acetate, butyl acetate, γ-butyrolactone, propylene glycol dimethyl ether and nitromethane, by using a cation complex of Ni, Pd, Co or the like belonging to Group 8 of the Periodic Table or a cation complex-forming catalyst, such as [Pd(CH₃CN)₄][BF₄]₂, di-μ-chloro-bis(6-methoxybicyclo[2.2.1]hept-2-ene-endo-5σ,2π)-Pd (hereinafter simply referred to as “I”) with methylalmoxane (MAO), I with AgBF₄, I with AgSbF₆, [(η³-allyl)PdCl]₂ with AgSbF₆, [(η³-allyl)PdCl]₂ with AgBF₄, [(η³-crotyl)Pd(cyclooctadiene)][PF₆], [(ρ³-crotyl)Ni(cyclooctadiene)][B((CF₃)₂C₆H₄)₄], [NiBr(NPMe₃)]₄ with MAO, Ni(octoate)₂ with MAO, Ni(octoate)₂ with B(C₆F₅)₃ and AlEt₃, Ni(octoate)₂ with [ph₃C][B(C₆F₅)₄] and Ali-Bu₃, and Co(neodecanoate) with MAO, whereby the polymer of the present invention can be obtained.

Furthermore, the methods described in Macromolecules, Vol. 29, page 2755 (1996), Macromolecules, Vol. 35, page 8969 (2002), and International Publication No. WO2004/7564 may also be suitably used.

In the present invention, x and y indicating the ratio (molar ratio) between formula (1A) and formula (1B) satisfy the relationship of 0.03≦y/(x+y)≦0.50. If y/(x+y)≦0.03, that is, if the OH amount is small, the cold-gelling ability (strippability) decreases, whereas if y/(x+y)>0.5, that is, if the OH amount is large, the polymer does not dissolve in a solvent. In order to suitably achieve both properties, the relationship of 0.03≦y/(x+y)≦0.50 must be satisfied, and the relationship is preferably 0.05≦y/(x+y)≦0.50, more preferably 0.05≦y/(x+y)≦0.40, and most preferably 0.10≦y/(x+y)≦0.40. x and y can be set to this range by employing a conventional hydrolysis or solvolysis method and appropriately adjusting the hydrolysis or solvolysis degree.

The value of y/(x+y), that is, the proportion of the OH group, can be measured by a spectroscopic method such as IR. Also, after benzoylating OH of the polymer with an excess base and benzoyl chloride and measuring ¹HNMR thereof, the proportion can be calculated from the integration ratio between the benzoyl moiety and other moieties. The obtained value corresponds to the proportion of original OH and therefore, the OH content of the original polymer, that is, y can be calculated.

In formulae (1A) and (1B), when n=q=1 and A=OCOR², the stereochemistry of the side chain having OCOR² and OH, that is, the endo/exo ratio, affects the cold-gelling ability (strippability). In order to obtain more suitable strippability, the total endo ratio is preferably from 50 to 100%, more preferably from 50 to 90%, and most preferably from 60 to 90%. For setting the endo/exo ratio in this range, the endo/exo ratio of the monomer before polymerization is set to an appropriate value. The ratio may also be set to the range above by adjusting the conditions or yield of the polymerization.

With respect to the term “endo/exo” used here, as shown below, when the bridgehead position of a norbornene ring and a substituent A bonded thereto are in the same direction, this is referred to as an exo form, and when in the opposite direction, this is referred to as an endo form. Unless the A-carbon bond is broken, the endo/exo ratio does not change.

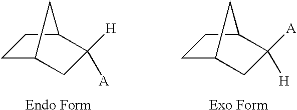

The endo/exo ratio in the polymer may be determined by a spectroscopic method such as ¹³CNMR but can also be exactly calculated as follows. A raw material monomer with endo/exo=x/(100−x) is polymerized, and endo/exo of the residual monomer generated when obtaining the polymer at a yield of w % is indicated by y/(100−y). Incidentally, it is known that in the polymerization reaction, the endo form and the exo form differ in the reaction rate (see, for example, Macromolecular Chemistry, Vol. 193, page 2915 (1992) and Organometallics, Vol. 23, page 1680 (2004)). Therefore, the ratios of x/(100−x) and y/(100−y) are not necessarily the same.

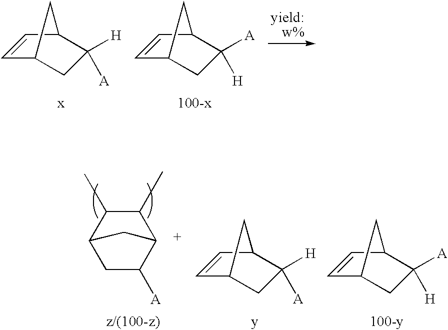

At this time, when only the endo form is taken notice of, the following relationship of material balance is established:

x=z×w/100+y×(100−w)/100

The endo/exo ratios of the raw material monomer and the residual monomer, that is, x/(100−x) and y/(100−y), can be exactly measured by NMR, gas chromatography or the like. The yield w can also be determined. By substituting these values, the endo/oxo=z/(100−z) in the polymer can be obtained.

In the cyclic olefin polymer of the present invention, the number average molecular weight in terms of polystyrene as measured by gel permeation chromatogram using tetrahydrofuran for the solvent is from 70,000 to 300,000, preferably from 70,000 to 250,000. Also, the weight average molecular weight in terms of polystyrene is from 200,000 to 700,000, preferably from 200,000 to 500,000. If the number average molecular weight in terms of polystyrene is less than 70,000 and the weight average molecular weight is less than 200,000, insufficient strippability at the film production and insufficient rupture strength may result, whereas if the number average molecular weight in terms of polystyrene exceeds 300,000 and the weight average molecular weight exceeds 700,000, the shape formability into a sheet may deteriorate or when forming a cast film or the like, the handling may become difficult due to high solution viscosity.

The glass transition temperature of the cyclic olefin polymer of the present invention is, as measured by a scanning differential calorimeter (DSC), preferably from 100 to 400° C., more preferably from 150 to 380° C., still more preferably from 200 to 350° C. If the glass transition temperature is less than 100C, thermal deformation readily occurs in use as an optical material, whereas if it exceeds 400° C., the polymer may undergo thermal decomposition when shape forming under heat is performed.

The tensile modulus of the cyclic olefin polymer of the present invention is preferably 1,200 MPa or more, more preferably 1,500 MPa or more. If the tensile modulus is low, the film lacks self-supporting property and may become difficult to handle as an optical material such as polarizing plate.

The cyclic olefin polymer of the present invention can be converted into a crosslinked form by applying heat or the like after adding a crosslinking agent such as silane coupling agent including peroxide, sulfur, disulfide, polysulfide compound, dioxime compound and tetrasulfide, in an amount of 0.05 to 5 parts by weight per 100 parts by weight of the polymer of the present invention, or may be converted into a crosslinked form by directly applying light or an electron beam.

### (Physical Properties of Polymer)

### (Determination of Cold-Gelling Ability)

The cyclic olefin polymer of the present invention has a cold-gelling ability. A polymer having a cold-gelling ability can be determined by measuring the viscoelasticity by a rheometer or the like. When a polymer dope is cooled, the viscosity abruptly increases at a certain temperature. Having a cold-gelling ability is to have such a temperature. However, the purpose of the present invention is to determine a polymer capable of high-speed film formation and therefore, the determination is preferably performed by actually examining a film formed by cold casting. The ability may also be determined by performing a simple test on a small scale. A polymer dope may be actually cast and film-formed on a small-amount scale by using a cooled metal plate to confirm the strippability. For example, a polymer is dissolved in a mixed solvent of methylene chloride/methanol/butanol/water or the like, and the obtained dope is cast and film-formed by using an applicator on an SUS plate set to a temperature of 0° C. to −40° C. This film is stripped off and when an unstripped film is not found on the SUS plate, the polymer can be judged as being capable of high-speed film formation.

### (Polymer Film)

The optical material of the present invention is characterized by using the cyclic olefin polymer, and the optical material is preferably in a thin-film, film or sheet form. In the following, a film is described as an example.

The film of the present invention indicates a film containing the cyclic olefin polymer. The film produced using the polymer is suitable as a film for optics applications including a liquid crystal display substrate, a light guide plate, a polarizing film, a phase difference film, a liquid crystal backlight, a liquid crystal panel, an OHP film and a transparent electrically conductive film.

### (Production Method of Polymer Film)

The film of the present invention contains the cyclic olefin polymer and can be produced by the film formation using the polymer as a raw material. For the film formation, a solution film-forming method enabling to obtain a film with excellent film state is preferably used. As to the method and equipment for producing the film of the present invention, the same solution casting film-forming method and solution casting film-forming apparatus as those conventionally used in the production of a cellulose triacetate film are used. The dope prepared in a dissolving machine (kettle) is once stored in a storing kettle and finalized by removing the bubbles contained in the dope.

The techniques for cellulose acylate film formation described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650 may be applied in the present invention. The solution film-forming method is described below.

### (Solvent)

As to the solvent for the preparation of a dope used in the solution casting film-forming method of the present invention, known solvents all may be used. Preferred examples thereof include, but are not limited to, halogenated hydrocarbons such as methylene chloride (dichloromethane), esters such as methyl acetate, ethers, alcohols (e.g., methanol, ethanol, n-butanol), and ketones (e.g., acetone). A film may also be produced by mixing a plurality of these solvents, preparing a dope from the resulting solvent, and film-forming the dope. In the present invention, it is particularly preferred to use a mixed solvent with the main solvent being methylene chloride, such as methylene chloride/methanol/butanol/water.

### (Additives)

The film of the present invention may contain additives other than the above-described polymer, and such an additive may be added at any stage in the process of producing the film. The additive may be selected according to the usage, and examples thereof include a plasticizer, a deterioration inhibitor, an ultraviolet inhibitor, a retardation (optical anisotropy) adjusting agent, a fine particle, a separation accelerator and an infrared absorbent. These additives may be a solid matter or an oily product. As for the timing of addition, in the case of film production by a solution casting method, the additive may be added at any stage in the process of preparing a dope, or a step of adding the additive to prepare a dope may be added as a final preparation step in the dope preparation process. The amount of each material added is not particularly limited as long as its function can be exerted. Also, in the case of forming a multilayer film, the kind or amount added of the additive may differ among the layers.

From the standpoint of preventing deterioration of the film, a deterioration (oxidation) inhibitor is preferably used. For example, there may be added a phenol-based or hydroquinone-based antioxidant such as 2,6-di-tert-butyl, 4-methylphenol, 4,4′-thiobis-(6-tert-butyl-3-methylphenol) and pentaerythrityl-tetrakis[3-(3,5-di-tert-butyl-4-hydroxyphenyl)propionate]. Furthermore, a phosphorus-based antioxidant such as tris(4-methoxy-3,5-diphenyl) phosphite, tris(nonylphenyl) phosphite and bis(2,4-di-tert-butylphenyl)pentaerythritol diphosphite is preferably added. The amount of the antioxidant added is from 0.05 to 5.0 parts by mass per 100 parts by mass of the polymer.

From the standpoint of preventing deterioration of the polarizing plate, liquid crystal and the like, an ultraviolet absorbent is preferably used. An ultraviolet absorbent having less absorption of visible light at a wavelength of 400 nm or more is preferably used in view of excellent ability of absorbing ultraviolet light at a wavelength of 370 nm or less and good liquid crystal display property. Specific examples of the ultraviolet absorbent which is preferably used in the present invention include a hindered phenol-based compound, an oxybenzophenone-based compound, a benzotriazole-based compound, a salicylic acid ester-based compound, a benzophenone-based compound, a cyanoacrylate-based compound and a nickel complex salt-based compound. The amount of the ultraviolet inhibitor added is, in terms of the ratio by mass, preferably from 1 ppm to 1.0%, more preferably from 10 to 1,000 ppm, based on the norbornene-based polymer.

In order to improve the slipperiness of the film surface, a fine particle (matting agent) is preferably used. By using this, irregularities are imparted to the film surface, that is, the roughness of the film surface is increased, whereby blocking of films to each other can be decreased. By virtue of the presence of a fine particle in the film or on at least one surface of the film, the adhesion between the polarizer and the film at the processing of a polarizing plate is remarkably enhanced. The matting agent for use in the present invention is, in the case of an inorganic fine particle, a fine particle having an average particle diameter of 0.05 to 0.5 μm, preferably from 0.08 to 0.3 μm, more preferably from 0.1 to 0.25 μm. The fine particle is, as the inorganic compound, preferably silicon dioxide, silicone or titanium dioxide and as the polymer compound, preferably fluororesin, nylon, polypropylene or chlorinated polyether. The fine particle is more preferably silicon dioxide, still more preferably silicon dioxide surface-treated with an organic material.

In order to reduce the separation resistance of the film, a separation accelerator is preferably used. As for the preferred releasing agent, a phosphoric acid ester-based surfactant, a carboxylic acid- or carboxylate-based surfactant, a sulfonic acid- or sulfonate-based surfactant, and a sulfuric acid ester-based surfactant are effective. A fluorine-containing surfactant where a part of hydrogen atoms bonded to the hydrocarbon chain of the surfactant above is replaced by a fluorine atom, is also effective. The amount of the releasing agent added is preferably from 0.05 to 5 mass %, more preferably from 0.1 to 2 mass %, and most preferably from 0.1 to 0.5 mass %.

### (Preparation of Dope)

The above-described solid materials (polymer and additives) are charged into the above-described methylene chloride-based solvent and dissolved by any known dissolution method to prepare a dope. This dope is generally filtered to remove foreign matters. For the filtration, various known filter materials such as filter paper, filter cloth, nonwoven fabric, metal mesh, sintered metal and porous plate can be used. By virtue of filtering the dope, foreign matters and undissolved matters in the dope can be removed and the product film can be reduced in the defect due to foreign matters in the film.

Also, the dope once prepared may be heated to more enhance the solubility. Examples of the heating include a method of heating the dope with stirring in a stationary tank, and a method of heating the dope by a heat exchanger of various types such as tubular system and jacketed piping with a static mixer, while transferring the dope. Also, a cooling step may be performed after the heating step. Furthermore, the dope can be heated to a temperature not less than its boiling point by pressurizing the inside of the apparatus. By performing such a treatment, fine undissolved matters can be completely dissolved and this enables reducing the foreign matters in the film and lightening the filtration load.

In the present invention, the weight percentage of the solid content in the dope (solid material concentration of the dope) is preferably from 15 to 30 wt %, more preferably from 20 to 25 wt %. If the weight percentage is less than 15 wt %, the solid material concentration of the dope is too low and a long time may be required until the gel film formed from the dope can have a preferred film stress, giving rise to a high cost. Also, if the solid material concentration is too low, a gel film may not be formed when the dope is cast. On the other hand, if it exceeds 30 wt %, the viscosity of the dope becomes excessively high to hardly allow for a leveling effect (smoothening) by beads and a uniform film can be hardly formed.

### (Solution Casting Film-Forming Method)

The solution casting film-forming method is described in many publications. In the recent solution casting film-forming method, the issue is to enhance the productivity in the film-forming process by shortening the time required from casting of the dope on a support until separation of the film formed on the support. For example, in JP-B-5-17844 (the term “JP-B” as used herein means an “examined Japanese patent publication”), it is proposed to cast a high-concentration dope on a cooled drum, thereby shortening the time from casting to stripping. In the film formation of the present invention, this drum film-forming method is preferably used. The drum film-forming method is described below.

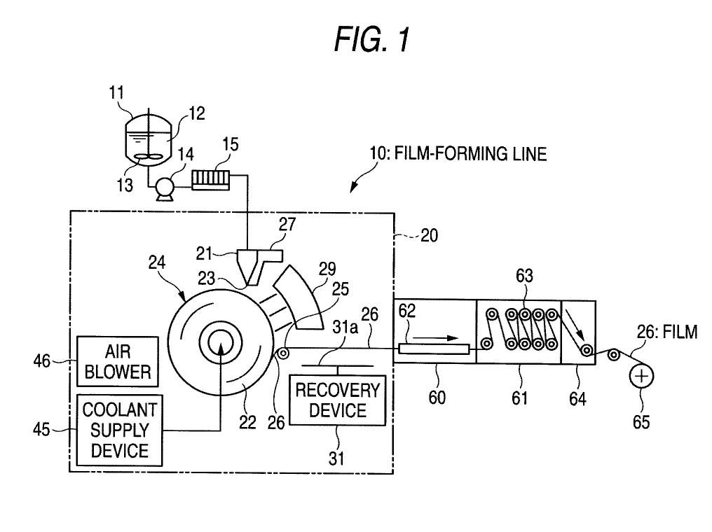

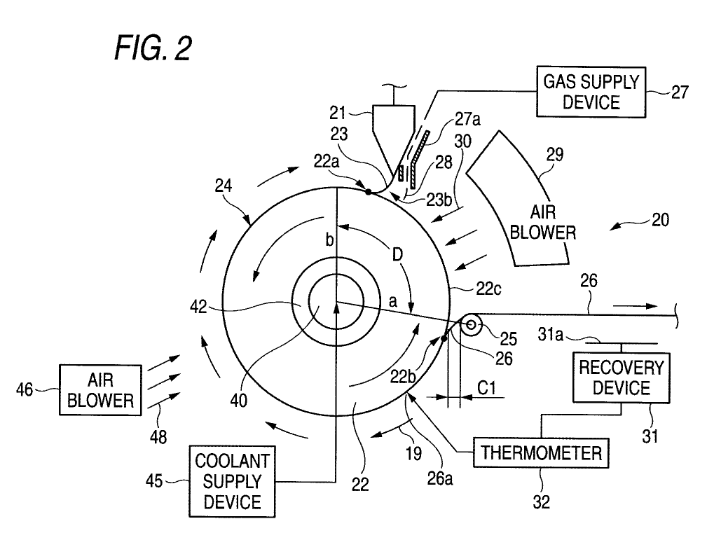

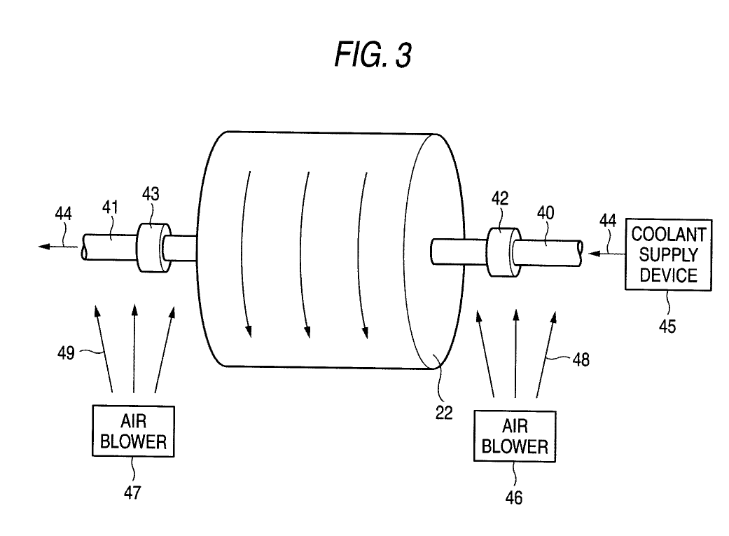

FIG. 1 shows a schematic view of a film-forming line 10 used for practicing the solution casting film-forming method according to the present invention. Also, FIGS. 2 and 3 each shows a schematic view of main parts of the film-forming line 10. In a mixing tank 11, a dope 12 prepared by the above-described method is charged and stirred with a stirring blade 13 to become uniform. The dope 12 is fed to a filtering device 15 by a pump 14 and after removing impurities there, fed at a constant flow rate to a casting die 21 provided in a casting chamber 20. The casting die 21 is disposed above a rotating drum 22. The rotating drum 22 is driven to rotate by a drive unit not shown. The dope 12 is cast on the rotating drum 22 from the casting die 21 to form a cast bead 23. Incidentally, in the present invention, the position at which the cast bead 23 lands on the rotating drum 22 is referred to as a landing line (see, FIG. 2; in the Figure, the landing line is shown by a point because this is viewed from the orthogonal direction to the film running direction) 22a. The cast bead 23 becomes a gel film 24 resulting from the progress of gelling on the rotating drum 22. The gel film 24 is cooled when moved along with the running of the rotating drum 22, whereby the gelling further proceeds. The gel film 24 reached the stripping line (see, FIG. 2) 22b is stripped from the rotating drum 22 by a stripping roller 25 and becomes a film 26. Here, it is more preferred to blow a drying air 19 from an air blower (not shown) inversely to the rotational direction of the rotating drum 22.

The rotating drum 22 where as shown in FIG. 3, support-rotating shafts (hereinafter referred to as a “rotating shaft”) 40 and 41 are fixed and shaft bearings 42 and 43 are fixed to the rotating shafts 40 and 41, is provided in a casting apparatus body not shown and driven to rotate. Inside of the rotation shaft 40, rotating drum 22 and rotation shaft 41, a medium flow path (not shown) is provided. A cooling medium (hereinafter referred to as a “coolant”) 44 which is a nonfreezing heat medium is supplied to the flow path from a coolant supply device 45, whereby the rotating drum 22 is cooled. In the present invention, the rotating drum 22 is preferably cooled to a surface temperature of 10° C. or less, more preferably −5° C. or less, and most preferably −20° C. or less. However, the present invention is not limited to these temperature ranges.

As for the coolant 44, a glycol-based coolant, a fluorine-based coolant, an alcohol-based coolant and the like are used, and Fluorinert (registered trademark) FC-77 and HFE7100, and COLD-BRINE (registered trademark) FP 60 are most preferred, but the present invention is not limited to these coolants. Also, the method for cooling the rotating drum, which is used in the present invention, is not always limited to the method of passing a coolant as shown in FIG. 3.

The rotating drum 22 for use in the present invention is preferably produced using a material having low-temperature brittleness, because the drum when cooled to a low temperature can be prevented from reduction in the resistance to shock of equipment or load of repeated use. Specifically, a drum produced using an SUS material, an SLA material, an STPL material or the like is preferred, but the drum is not limited thereto.

As shown in FIG. 2, a gas pipeline 27a connected to a gas supply device 27 is preferably fixed to the casting die 21 on the bead back surface 23b side. A gas (hereinafter, sometimes referred to as a “first gas”) 28 is blown to the bead back surface 23b through the gas pipeline 27a, whereby the gas concentration on the bead back surface 23b can be reduced and the dew point can be lowered and whereby dew condensation on the surface of the rotating drum 22 and degradation of the surface quality of the film 26 can be prevented. Furthermore, in the case where dew condensation occurs on the rotating drum 22 surface, when the gel film 24 is formed, the gel film 24 falls off from the rotating drum 22 between the landing line 22a and the stripping line 22b and the continuous operation is disturbed. According to the present invention, dew condensation on the rotating drum 22 surface can be prevented and therefore, falling-off of the gel film 24 can be also prevented. Here, the gas 28 used is preferably a gas not affecting the characteristics of the film, such as nitrogen gas and helium gas (usually called an inert gas).

Also, after adjusting the temperature of the gas 28 by the gas supply device 27, air is preferably blown so that the dew point can become lower than the surface temperature of the rotating drum 22 by 1° C. or more. Incidentally, the temperature on the rotating drum 22 surface may be measured by any known apparatus (the thermometer is not shown). If this temperature difference is less than 1° C., dew condensation occurs with little fluctuation in the process conditions. Furthermore, the flow velocity of the gas 28 is preferably in the range of 0.5 to 2 m/s. If the flow velocity is less than 0.5 m/s, the effect of reducing the gas concentration in the vicinity of the cast bead 23 is insufficient, whereas if the flow velocity exceeds 2 m/s, flow unevenness may occur on the cast bead 23 to deteriorate the surface quality of the film. The temperature of the first gas 28 is preferably from 30 to 50° C. However, in the present invention, the flow velocity and temperature of the gas (first gas) are not limited to the ranges above because other test conditions may be changed.

The dope 12 cast on the rotating drum 22 surface is cold-gelled to increase the strength (film strength) of the gel film 24, and the strength (film strength) of the gel film 24 is further increased resulting from acceleration of drying until stripping. If the stress (film stress) by the stretching of the gel film 24 at the stripping is less than 450,000 Pa, the strength as a film is insufficient and a self-supporting property necessary for stripping may not be obtained. In the present invention, the value of stress by stretching is preferably 450,000 Pa or more, more preferably 600,000 Pa or more, and most preferably 750,000 Pa or more. Here, in the present invention, a value measured at the stretching using a load cell is used as the value of stress by the stretching of the film.

Also, at the time of stripping the gel film 24 as a film 26, the velocity ratio V1/V0 between the circumferential velocity (V0) of the rotating drum 22 and the circumferential velocity (V1) of the stripping roller 25 is preferably in the range of 1.001≦(V1/V0)≦1.5, more preferably 1.002≦(V1/V0)≦1.3, and most preferably 1.005≦(V1/V0)≦1.2. When the ratio of (V1/V0) is in this range, the stretch force applied to the film 26 is increased to yield stable stripping. If the velocity ratio is less than 1.001, the stretch force for the film is insufficient and the stripping line 22b rises, making it difficult to uniformly strip the film, whereas if the velocity ratio exceeds 1.5, the film with a high volatile content (soft film) immediately after stripping may suffer from a problem such as “breakage” or “wrinkling” from selvedges due to abrupt stretching. Here, in the present invention, the velocity ratio (V1/V0) is not limited to the range above.

When the clearance C1 between the rotating drum 22 and the stripping roller 25 is made narrow, the stretch speed increases and therefore, the stretch force becomes large to yield stable stripping. However, if the clearance C1 is less than 1 mm, the film may be broken due to trapping of foreign matters such as film debris, whereas if the clearance C1 exceeds 100 mm, the effect of increasing the stretch force for the film decreases to cause a rise in the stripping position and the stripping may become unstable. In the present invention, the clearance C1 is preferably 1 mm≦C1≦100 mm but is not limited to this range. Incidentally, the term “clearance C1” as used in the present invention means a distance between intersections at which the line a connecting respective centers of rotating drum 22 and stripping roller 25 disposed on the same plane crosses with respective outer circumferences. Also, the stripping roller 25 is preferably disposed at a position defining an angle D of 45 to 180°, more preferably from 60 to 120°, between the reference line (the reference line means, as shown in the Figure, a line vertically extending upward from the center of the rotating drum) b of the rotating drum 22 and the center line a.

In order to facilitate the stripping of the gel film 24 from the rotating drum 22, the difference between the surface tension of the rotating drum 22 and the surface tension of the dope 12 is preferably 3×10⁻² (N/m) or more. With this difference, the rotating drum 22 is less wetted with the solvent and the contact area between the gel film 24 and the rotating drum 22 becomes small, whereby the separation resistance at the stripping can be decreased and in turn, the stripping is stabilized. In the present invention, the surface tension can be measured by using any known method. Also, in the present invention, the difference in the surface tension is not limited to the above-described range.

In FIG. 2, the gel film 24 is not present on the rotating drum 22 between the stripping line 22b and the bead landing line 22a. In the present invention, the plane in this region is referred to as a gel film-free plane 22c. As described above, the rotating drum 22 is cooled by supplying a coolant thereinto. Accordingly, when the surface temperature of the gel film-free plane 22c reaches the dew point, dew condensation sometimes occurs. Also, since the rotating drum 22 is endlessly running, when the dope 12 is cast on the plane having attached thereto a water droplet or a condensed solvent, this may incur worsened surface state of the film produced. Accordingly, a gas (hereinafter sometimes referred to as a “second gas”) 30 is blown on the gel film-free plane 22c by using an air blower 29 to make the temperature on the gel film-free plane 22c higher than the dew point in the vicinity of the cast bead 23 by 1° C. or high, whereby attachment of a water droplet or a liquefied solvent can be prevented. Here, the temperature of the gas (second gas) 30 is preferably from 50 to 100° C., and the flow velocity is preferably from 2 to 10 m/s, but the present invention is not limited to these ranges.

As shown in FIG. 3, the coolant 44 is passed also inside the rotational shafts 40 and 41. Therefore, when the air in the vicinity of the rotational shafts 40 and 41 and shaft bearings 42 and 43 is cooled and reaches the dew point, the water vapor contained in the air is condensed to produce a water droplet. Also, a vaporized solvent volatilized from the dope 12 is contained in the casting chamber 20, and such a vaporized solvent may be liquefied and attach to the rotational shafts 40 and 41 and shaft bearings 42 and 43. The serious attachment may cause a rotation failure and disturb the continuous film formation. Therefore, in the present invention, air blowers 46 and 47 are provided in the vicinity of the rotational shafts 40 and 41 and shaft bearings 42 and 43 and gases (hereinafter sometimes referred to as a “third gas”) 48 and 49 are respectively blown to the rotational shafts 40 and 41 and shaft bearings 42 and 43, whereby dew condensation can be prevented from occurring on the rotational shafts 40 and 41 and shaft bearings 42 and 43. Incidentally, the gases 48 and 49 blown are not particularly limited as long as the temperature thereof does not allow the temperature in the vicinity of the rotational shafts 40 and 41 to reach the dew point or less, but specifically, the gas temperature is preferably from 20 to 30° C. Also, the flow velocity is preferably from 2 to 10 m/s but is not limited to this range. Furthermore, in the present invention, the embodiment of the air blower is not limited to that shown in FIG. 3. For example, in FIG. 3, air blowers 46 and 47 are disposed for the rotational shafts 40 and 41, respectively, but the gas may be blown to both of the rotational shafts 40 and 41 by using one unit of an air blower.

At the time of performing the solution casting film-forming method according to the present invention, the casting die 21, rotational drum 22 and the like are preferably installed in the casting chamber 20, because random air is prevented from blowing to the cast bead 23 and a film 26 having a uniform surface state is obtained. However, when dew condensation occurs in the casting chamber, a water droplet or the like may attach to the gel film 24 surface to produce a defect such as streak on the surface of the film. Also, when a liquid attaches to the rotational shafts 40 and 41, shaft bearings 42 and 43 (see FIG. 3) and the like and is condensed, the rotation number of the rotating drum 24 can be hardly controlled in some cases and there may be even a case where the rotation drum does not rotate at all. Therefore, a recovery device 31 for condensing and recovering the vaporized solvent is preferably disposed in the casting chamber 20.

The recovery device 31 comprises a condensing plane 31a for condensing a water vapor contained in the air inside of the casting chamber 20 or a vaporized solvent resulting from vaporization of the solvent in the gel film 24. The temperature of the condensing plane 31a is set according to the kind or the like of the solvent constituting the dope 12 and is not particularly limited, but in the present invention, the temperature is preferably set to be lower than the surface temperature of the film 26 by 1° C. or more, more preferably to be lower than the surface temperature of the film 26 by 1 to 20° C. If the temperature difference is less than 1° C., a liquid such as water droplet may attach to the film 26 surface with little fluctuation in the conditions of casting process, whereas if the temperature difference exceeds 20° C. or less, this is disadvantageous in view of the cost. Incidentally, in the present invention, the film surface temperature is preferably measured by using a non-contact thermometer 32 in the vicinity of a measuring point 26a shown in FIG. 2, but the method of measuring the temperature is not limited thereto. Also, the recovery device 31 preferably adjusts the temperature of the condensing plane 31a based on the temperature measured by the thermometer 32.

In order to further dry the film 26, a tenter chamber 60 and a drying chamber 61 are disposed downstream of the casting chamber 20 (see, FIG. 1). The film is preferably dried by a tenter dryer 62 in the tenter chamber 60 while stretching the film in the width direction for making uniform the surface state of the film 26. The film 26 is further fed to the drying chamber 61 where a large number of rollers 63 are disposed. The film 26 is dried during conveyance on those rollers 63. Furthermore, the film 26 is preferably cooled to nearly room temperature in a cooling chamber 64. Thereafter, the film is preferably taken up by a take-up machine 65. Incidentally, in the present invention, the film may be slit or knurled before being taken up. Also, the film-forming line 10 for use in the solution casting film-forming method according to the present invention is not limited to that shown in FIGS. 1 to 3.

The solution casting film-forming method of the invention is most suitable as a film-forming method for a film formed to a thickness of 20 to 120 μm (film with a small thickness), because the film stress at the stripping is large.

In FIG. 1, an embodiment where one kind of a dope is cast in a single layer is shown, but the present invention is not limited to the embodiment shown in the Figure. For example, there may also be applied a co-casting method where a feed block is fixed upstream of the casting die, a large number of dopes are fed to the feed block, and these dopes are joined in the feed block and co-cast. Furthermore, in the Figure, a rotating drum 22 is used as the support, but the present invention is not limited to the embodiment shown in the Figure and may be applied also to, for example, a solution casting film-forming method of casting the dope on a casting belt which is caused to endlessly run by a rotating roller.

### (Film Stretching)

In the case of further subjecting the film produced by the above-described solution casting film-forming method to a stretching treatment, the treatment is preferably performed while the solvent still sufficiently remains in the film immediately after the separation. The stretching is performed for the purpose of (1) obtaining a film with excellent planarity free of wrinkling or deformation and (2) increasing the in-plane retardation of the film. The stretching for the purpose of (1) is performed at a relatively high temperature at a low stretch ratio of 1% to at most 10%. Stretching of 2 to 5% is preferred. The stretching for both purposes of (1) and (2) or for only the purpose of (2) is performed at a relatively low temperature at a stretch ratio of 5 to 150%.

The film stretching may be uniaxial stretching only in the vertical or transverse direction or may be simultaneous or sequential biaxial stretching. The birefringence of the phase difference film for VA liquid crystal cell or OCB liquid crystal cell is preferably such that the refractive index in the width direction is larger than the refractive index in the length direction. Therefore, the film is preferably stretched at a larger stretch ratio in the width direction.

The thickness of the finished (after drying) film of the present invention varies depending on the intended use but is usually from 20 to 500 μm, preferably from 30 to 150 μm, and for a liquid crystal display, more preferably from 40 to 110 μm.

### (Optical Characteristics of Film)

The preferred optical characteristics of the film of the present invention vary depending on use of the film. Preferred ranges of the in-plane retardation (Re) and the retardation in the thickness direction (Rth), which are calculated in terms of a film thickness of 80 μm, in each application are described below.

In case of use as a polarizing plate protective film:

Re is preferably 0 nm≦Re≦5 nm, more preferably 0 nm≦Re≦3 nm, and Rth is preferably 0 nm≦Rth≦50 nm, more preferably 0 nm≦Rth≦35 nm, still more preferably 0 nm≦Rth≦10 nm.

In case of use as a phase difference film:

The ranges of Re and Rth each varies depending on the kind of the phase difference film and there are diversified needs, but these are preferably 0 nm≦Re≦100 nm and 0 nm≦Rth≦400 nm; more preferably 0 nm≦Re≦20 nm and 40 nm≦Rth≦80 nm for TN mode, and 20 nm≦Re≦80 nm and 80 nm≦Rth≦400 nm for VA mode; and still more preferably 30 nm≦Re≦75 nm and 120 nm≦Rth≦250 nm for VA mode, 50 nm≦Re≦75 nm and 180 nm≦Rth≦250 nm when compensating by one phase difference film, and 30 nm≦Re≦50 nm and 80 nm≦Rth≦140 nm when compensating by two phase difference films. These are preferred embodiments as a compensatory film of VA mode in view of the color shift at the black display time and the viewing angle dependency of contrast. Incidentally, the Re and Rth above are values measured at a wavelength of 590 nm.

The film of the present invention can realize desired optical characteristics by appropriately adjusting the copolymerization ratio, the kind and amount added of additive, the stretch ratio, the residual volatile content at the separation, and the like.

In the context of the present invention, Re(λ) and Rth(λ) indicate the in-plane retardation and the retardation in the thickness direction, respectively, at a wavelength of λ. Re(λ) is measured by making light at a wavelength of λ nm to be incident in the film normal line direction in KOBRA 21ADH or WR (manufactured by Oji Scientific Instruments). In selecting the measurement wavelength of λ nm, the retardation can be measured by manually exchanging the wavelength selecting filter or exchanging the measured value according to a program or the like.

In the case where the film measured is a film expressed by a uniaxial or biaxial refractive index ellipsoid, Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the in-plane slow axis (judged by KOBRA 21ADH or WR) being used as the inclination axis (rotation axis) (when the slow axis is not present, an arbitrary direction in the film plane is used as the rotation axis) and based on the retardation values measured, assumed values of average refractive index and film thickness values input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, assumed values of average refractive index and film thickness values input, Rth can also be calculated according to the following formulae (1) and (2).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 1 )$$

### Note:

Re(θ) above represents the retardation value in the direction inclined at an angle of θ from the normal direction. In formula (1), nx represents the refractive index in the in-plane slow axis direction, ny represents the refractive index in the direction crossing with nx at right angles in the plane, nz represents the refractive index in the direction crossing with nx and ny at right angles.

$$Rth = [ \frac{nx + ny}{2} - nz ] \times d \qquad Formula ( 2 )$$

In the case where the film measured is a film incapable of being expressed by a uniaxial or biaxial refractive index ellipsoid, that is, a film not having a so-called optic axis, Rth(λ) is calculated by the following method.

The above-described Re(λ) is measured at 11 points by making light at a wavelength of λ nm to be incident from directions inclined with respect the film normal direction in 10° steps from −50° to +50° with the inclination axis (rotation axis) being the in-plane slow axis (judged by KOBRA 21ADH or WR) and based on the retardation values measured, assumed values of average refractive index and film thickness values input, Rth(λ) is calculated by KOBRA 21ADH or WR.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

### (Physical Properties of Polymer Film)

In the case of using the film of the present invention as a protective film of a polarizing plate, it is preferred that the value of photoelasticity is from 0.5×10⁻¹³ to 9.0×10⁻¹³ (cm²/dyn) and the value of moisture permeability (the value in terms of a film thickness of 80 μm) is from 180 to 435 (g/cm²-24 h). The value of photoelasticity is more preferably from 0.5×10⁻¹³ to 7.0×10⁻¹³ (cm²/dyn), still more preferably from 0.5×10⁻¹³ to 5.0×10⁻¹³ (cm²/dyn). Also, the value of moisture permeability (the value in terms of a film thickness of 80 μm) is more preferably from 180 to 400 (g/cm²-24 h), still more preferably from 180 to 350 (g/cm²-24 h). When the film of the present invention having these properties is used as a protective film of a polarizing plate, deterioration in the performance by the effect of humidity can be reduced.

### (Polarizing Plate)

The polarizing plate of the present invention has at least the film of the present invention and a polarizing film. Usually, the polarizing plate has a polarizing film and two protective films disposed on both sides thereof. The film of the present invention can be used as a protective film on both sides or on one side. The protective film on the other side may be a normal cellulose acetate film or the like. The polarizing film includes an iodine-based polarizing film, a dye-based polarizing film using a dichromatic dye, and a polyene-based polarizing film. The iodine-based polarizing film and dye-based polarizing film are generally produced using a polyvinyl alcohol-based film. In the case of using the film of the present invention as a polarizing plate protective film, the film is subjected to a surface treatment described later, and then the treated surface of the film and the polarizing film are stacked together using an adhesive. Examples of the adhesive used include a polyvinyl alcohol-based adhesive such as polyvinyl alcohol and polyvinyl butyral, a vinyl-based latex such as butyl acrylate, and gelatin. The polarizing plate is composed of a polarizing film and protective films protecting both surfaces thereof and is fabricated by further laminating a protect film to one surface of the polarizing plate and a separate film to the opposite surface. The protect film and separate film are used for the purpose of protecting the polarizing plate, for example, at the shipment of polarizing plate or at the product inspection. In this case, the protect film is stacked for the purpose of protecting the polarizing plate surface and used on the surface opposite the surface through which the polarizing plate is stacked to a liquid crystal plate. The separate film is used for the purpose of covering the adhesive layer which adheres to a liquid crystal plate and used on the surface through which the polarizing plate is stacked to a liquid crystal plate. The film of the present invention is preferably stacked to the polarizing film such that the transmission axis of the polarizing film agrees with the slow axis of the film.

### (Surface Treatment of Film)

In the present invention, the film surface is preferably surface-treated so as to improve the adhesive property between the polarizing film and the protective film. As for the surface treatment, any method may be used as long as the adhesive property can be improved, but preferred examples of the surface treatment include a glow discharge treatment, an ultraviolet irradiation treatment, a corona treatment and a flame treatment. The glow discharge treatment as referred to herein is a so-called low-temperature plasma which occurs under a low-pressure gas. In the present invention, a plasma treatment under atmospheric pressure is also preferred. Other details of the glow discharge treatment are described in U.S. Pat. Nos. 3,462,335, 3,761,299 and 4,072,769, and British Patent 891,469. There may be also used the method described in JP-T-59-556430 (the term “JP-T” as used herein means a “published Japanese translation of a PCT patent application”) where the gas composition in discharge atmosphere is limited only to the gas species generated in a vessel when after starting the discharge, a polyester support itself is subjected to a discharge treatment. Furthermore, the method described in JP-B-60-16614 can also be applied, where in performing a vacuum glow discharge treatment, the discharge treatment is performed by setting the film surface temperature to 80 to 180° C.

The preferred degree of surface treatment varies depending on the kind of surface treatment, but it is preferred that as a result of the surface treatment, the surface of the protective film subjected to the surface treatment comes to have a contact angle for pure water of less than 50°. The contact angle is more preferably from 25° to less than 45°. When the contact angle of the protective film surface for pure water is in the range above, good adhesive strength is obtained between the protective film and the polarizing film.

### (Adhesive)

In stacking together the polarizing film comprising a polyvinyl alcohol and the surface-treated film of the present invention, an adhesive containing a water-soluble polymer is preferably used. Examples of the water-soluble polymer which is preferably used for the adhesive include a homopolymer or polymer containing, as a constitutional element, an ethylenically unsaturated monomer such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetone acrylamide and vinylimidazole; and also include polyoxyethylene, polyoxypropylene, poly-2-methyloxazoline, methyl cellulose, hydroxyethyl cellulose, hydroxypropyl cellulose and gelatin. Among these, PVA and gelatin are preferred in the present invention. The dry thickness of the adhesive layer is preferably from 0.01 to 5 μm, more preferably from 0.05 to 3 μm.

### (Antireflection Layer)

A functional layer such as antireflection layer is preferably provided on the polarizing plate protective film disposed on the side opposite the liquid crystal cell. Particularly, in the present invention, an antireflection layer obtained by stacking at least a light-scattering layer and a low refractive index layer in this order on the protective layer, or an antireflection layer obtained by stacking a medium refractive index layer, a high refractive index layer and a low refractive index layer in this order on the protective film is suitably used.

### (Light-Scattering Layer)

The light-scattering layer is formed for the purpose of providing the film with a light-scattering property by surface scattering and/or internal scattering, and a hardcoat property for enhancing the scratch resistance of the film. Accordingly, the light-scattering layer is formed comprising a binder for imparting a hardcoat property, a matting particle for imparting a light-scattering property, and, if desired, an inorganic filler for elevating the refractive index, preventing crosslinking shrinkage or increasing the strength. In view of imparting a hardcoat property and suppressing the generation of curling or an increase in the brittleness, the thickness of the light-scattering layer is preferably from 1 to 10 μm, more preferably from 1.2 to 6 μm.

### (Other Layers of Antireflection Layer)

A hardcoat layer, a forward scattering layer, a primer layer, an antistatic layer, an undercoat layer, a protective layer and the like may be further provided.

### (Hardcoat Layer)

The hardcoat layer is provided on the transparent support surface so as to impart physical strength to the protective film having provided thereon the antireflection layer. In particular, the hardcoat layer is preferably provided between the transparent support and the high refractive index layer. The hardcoat layer is preferably formed through a crosslinking or polymerization reaction of a photo- and/or heat-curable compound. The curable functional group is preferably a photopolymerizable functional group, and the hydrolyzable functional group-containing organic metal compound is preferably an organic alkoxysilyl compound.

### (Antistatic Layer)

In the case of providing an antistatic layer, an electrical conductivity of 10⁻⁸ (Ωcm⁻³) or less in terms of the volume resistivity is preferably imparted. A volume resistivity of 10⁻⁸ (Ω·cm⁻³) may be imparted using a hygroscopic substance, a water-soluble inorganic salt, a certain kind of surfactant, a cationic polymer, an anionic polymer, a colloidal silica or the like, but these have a problem that the temperature and humidity dependency is large and a sufficient electrical conductivity cannot be ensured at a low humidity. Therefore, the material for the electrically conductive layer is preferably a metal oxide.

### (Liquid Crystal Display)

The film of the present invention, the phase retardation film comprising the film of the present invention, and the polarizing plate using the film of the present invention can be used for liquid crystal cells and liquid crystal displays in various display modes. There are proposed various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic). Of these, OCB mode and VA mode are preferred.

### EXAMPLES

Exemplary embodiments of the present invention are described in greater detail below by referring to Examples. The materials, amount used, ratios, treatment contents, treatment procedures and the like described in the following Examples can be appropriately varied or modified without departing from the purport of the present invention. Accordingly, the scope of the present invention is not limited to these specific Examples.

### (Synthesis of Norbornene-Based Compound)

Methyl norbornenecarboxylate (NBCO₂CH₃), norborneneol (NBOH) and norbornene (NB) for use in the present invention were purchased from Tokyo Kasei Kogyo Co., Ltd. and Aldrich. From gas chromatography, NBCO₂CH₃ was found to have a purity of 98.5% and an endo/exo ratio of 49/51, NBOH was found to have a purity of 98.0% and an endo/exo ratio of 78/22, and NB was found to have a purity of 98.1%. These are denoted like NBCO₂CH₃ (49/51), NBOH (78/22) and NB. Hereinafter, the same applies. Other norbornene-based compounds were produced as in the following Synthesis Examples.

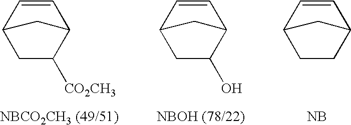

### Synthesis Example 1

### Synthesis of M-1 (83/17)

Dicyclopentadiene (10,940 g) (produced by Wako Pure Chemical Industries, Ltd.), 17,720 g of allyl acetate (produced by Wako Pure Chemical Industries, Ltd.) and 10 g of hydroquinone (produced by Wako Pure Chemical Industries, Ltd.) were charged into an autoclave, and the airgap was nitrogen-substituted. The mixture was stirred in a closed system at an internal temperature of 180° C. for 9 hours (rotation speed: 300 rpm). The resulting material was subjected to precise distillation (column length: 120 cm, column packing material: Propak, reflux ratio: 10/1, pressure: 10 mmHg, top temperature: 89° C.) to obtain colorless transparent M-1. This compound was measured for its peak purity by gas chromatography and found to have a purity of 99.9% and an endo/exo ratio of 83/17.

### Synthesis Example 2

### Synthesis of M-2 (83/17)

Colorless transparent M-2 was obtained in the same manner as in Synthesis Example 1 except for changing allyl acetate to allyl hexanoate (produced by Wako Pure Chemical Industries, Ltd.) in Synthesis Example 1. This compound was measured for its peak purity by gas chromatography and found to have a purity of 99.0% and an endo/exo ratio of 83/17.

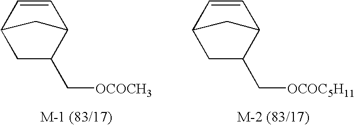

### Synthesis Example 3

### Synthesis of M-1 (49/51)

Dehydrated tetrahydrofuran (4,000 mL) and 203 g of lithium aluminum hydride were charged into a flask and cooled in an ice bath. Thereto, a mixture of 1,173 g of NBCO₂CH₃ (49/51) and 1,000 mL of dehydrated tetrahydrofuran was added dropwise. After returning the temperature to room temperature, 1,000 g of an aqueous 27% sodium hydroxide solution was added dropwise, and the resulting solution was subjected to Celite filtration and evaporation to obtain crude norbornene methanol as a white turbid liquid. This compound was charged into a flask together with 1,000 mL of ethyl acetate, 900 mL of pyridine and 1,050 g of acetic anhydride, and the contents were stirred at room temperature for 3 hours. The resulting solution was poured into an ice bath to effect extraction by liquid separation. The organic layer was dried over magnesium sulfate and subjected to filtration and evaporation. The remaining liquid was distilled under reduced pressure to obtain colorless M-1. This compound was analyzed by gas chromatography and found to have a purity of 99.7% and an endo/exo ratio of 49/51.

### Synthesis Example 4

### Synthesis of M-2 (49/51)

M-2 was obtained in the same manner as in Synthesis Example 3 except for changing acetic anhydride to hexanoic anhydride (produced by Wako Pure Chemical Industries, Ltd.) in Synthesis Example 3. This compound was analyzed by gas chromatography and found to have a purity of 99.8% and an endo/exo ratio of 49/51.

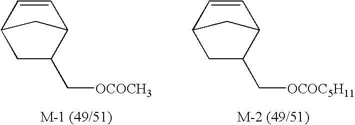

### Synthesis Example 5

### Synthesis of M-1 (3/97)

NBCO₂CH₃ (49/51) (2,390 g) was subjected to precise distillation (column: 30 mm in diameter and 1,800 mm in length, reflux ratio: 1/30 (open/close), 10 mmHg). As a result of analysis by gas chromatography, NBCO₂CH₃ (3/97) having a purity of 99.9% and an endo/exo ratio of 3/97 was obtained. This compound was subjected to reduction, acetylation and purification by distillation in the same manner as in Synthesis Example 3. It is found from the analysis by gas chromatography that M-1 (3/97) having a purity of 99.5% and an endo/exo ratio of 3/97 was obtained.

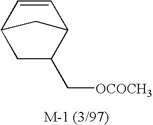

### Synthesis Example 6

### Synthesis of M-3 (78/22)

M-3 was obtained starting from NBOH (78/22) by performing acetylation and purification by distillation in the same manner as in Synthesis Example 5. This compound was analyzed by gas chromatography and found to have a purity of 99.8% and an endo/exo ratio of 78/22.

### Synthesis Example 7

### Synthesis of M-4 (78/22)

M-4 was obtained starting from NBOH (78/22) by performing hexanoylation and purification by distillation in the same manner as in Synthesis Example 5. This compound was analyzed by gas chromatography and found to have a purity of 99.2% and an endo/exo ratio of 78/22.

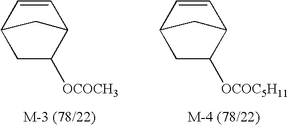

### Synthesis Example 8

### Synthesis of M-3 (0/100)

Norbornadiene (1,790 g) (produced by Tokyo Kasei Kogyo Co., Ltd.), 1,040 g of acetic acid (produced by Wako Pure Chemical Industries, Ltd.) and 30 g of tris-(triphenylphosphine)platinum were charged into an autoclave, and the contents were continuously stirred at 120° C. for 75 hours. The obtained solution was subjected to evaporation and distillation under reduced pressure to obtain colorless M-1. From gas chromatography, this compound was found to have a purity of 99.5% and an endo/exo ratio of 0/100.

### Synthesis Example 9

### Synthesis of M-4 (0/100)

M-3 (0/100) (1,390 g) obtained in Synthesis Example 8, 4,500 mL of methanol and 1,430 g of potassium hydroxide dissolved in 1,500 mL of water were charged into a flask, and the contents were refluxed for 4 hours. After neutralization with 2,000 mL of concentrated hydrochloric acid and extraction with ethyl acetate, the resulting solution was dried over magnesium sulfate and then subjected to filtration and evaporation. Subsequently, 2,000 mL of the obtained brown liquid acetonitrile was charged with 790 g of pyridine, 1,260 g of hexanoic acid chloride was added dropwise, and the mixture was refluxed at 70° C. for 2 hours. The refluxed product was extracted with ethyl acetate/water, dried over magnesium sulfate and then subjected to drying, evaporation and distillation under reduced pressure to obtain M-4 as a colorless liquid. From gas chromatography, this compound was found to have a purity of 99.7% and an endo/exo ratio of 0/100.

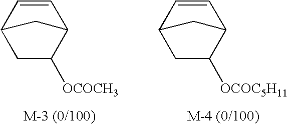

### (Preparation by Mixing)

M-1 to M-4 having an endo/exo ratio shown below were synthesized by appropriately mixing M-1 to M-4 obtained above. From gas chromatography, these compounds all were found to have a purity 99% or more.

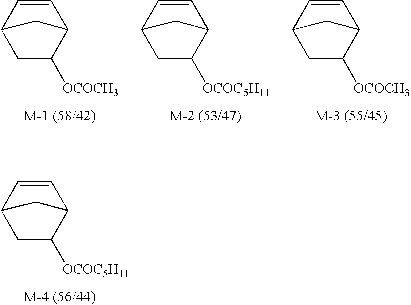

### Synthesis Example 10

### Synthesis of NBCO₂C₂H₄OH

Dicyclopentadiene (1,600 g) (produced by Wako Pure Chemical Industries, Ltd.), 2,810 g of 2-hydroxyethyl acrylate (produced by Wako Pure Chemical Industries, Ltd.) and 1 g of hydroquinone (produced by Wako Pure Chemical Industries, Ltd.) were charged into an autoclave, and the airgap was nitrogen-substituted. The mixture was stirred in a closed system at an internal temperature of 180° C. for 4 hours (rotation speed: 300 rpm). The resulting material was subjected to simple distillation to obtain colorless transparent NBCO₂C₂H₄OH. This compound was measured for its peak purity by gas chromatography and found to have a purity of 98.0% and an endo/exo ratio of 45/55.

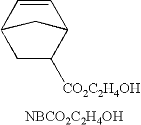

### Synthesis Example 11

### Synthesis of NBCO₂C₂H₉

Dicyclopentadiene (1,150 g) (produced by Wako Pure Chemical Industries, Ltd.), 2,230 g of butyl acrylate (produced by Wako Pure Chemical Industries, Ltd.) and 1 g of hydroquinone (produced by Wako Pure Chemical Industries, Ltd.) were charged into an autoclave, and the airgap was nitrogen-substituted. The mixture was stirred in a closed system at an internal temperature of 240° C. for 4 hours (rotation speed: 300 rpm). The resulting material was subjected to simple distillation to obtain colorless transparent NBCO₂C₂H₉. This compound was measured for its peak purity by gas chromatography and found to have a purity of 98.9% and an endo/exo ratio of 45/55.

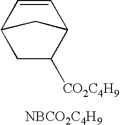

### Synthesis Example 12

### Synthesis of NBC₆H₁₃

Dicyclopentadiene (1,854 g) (produced by Wako Pure Chemical Industries, Ltd.), 3,635 g of 1-octene (produced by Wako Pure Chemical Industries, Ltd.) and 1 g of hydroquinone (produced by Wako Pure Chemical Industries, Ltd.) were charged into an autoclave, and the airgap was nitrogen-substituted. The mixture was stirred in a closed system at an internal temperature of 200° C. for 6 hours (rotation speed: 300 rpm). The resulting material was subjected to simple distillation to obtain colorless transparent NBC₆H₁₃. This compound was measured for its peak purity by gas chromatography and found to have a purity of 97.8% and an endo/exo ratio of 80/20.

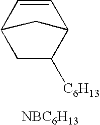

### (Synthesis of Norbornene-Based Polymer)

### Polymerization Example 1

Purified toluene (6,000 mL) and 1,190 g of Monomer M-1 (83/17) were charged into a reaction vessel, and then, 480 mg of palladium acetyl acetonate (produced by Tokyo Kasei Kogyo Co., Ltd.) dissolved in 100 mL of toluene, 460 mg of tricyclohexylphosphine (produced by Strem Chemicals, Inc.), and 2,560 mg of dimethylanilinium tetrakispentafluorophenyl borate (produced by Strem Chemicals, Inc.) dissolved in 100 mL of methylene chloride were charged into the reaction vessel. Heating was started and the contents were stirred at 90° C. for 6 hours at 300 rpm. During the stirring, toluene was appropriately added with the increase in the viscosity of the reaction solution. The obtained reaction solution was charged into excess methanol to precipitate Polymerization Product P1. The precipitate was collected and washed with methanol. The obtained polymer was vacuum-dried at 110° C. for 6 hours to obtain 1,130 g (yield: 95%) of a white solid. The reprecipitation filtrate was concentrated and analyzed by gas chromatography, as a result, the endo/exo ratio of the residual Monomer M-1 was found to be 98/2. From this result, the endo/exo ratio in P1 was calculated as 82/18. The P1 obtained here is denoted as P1 (82/18). In the following, the polymers are denoted in the same manner. The obtained polymer was dissolved in tetrahydrofuran and measured for the weight average molecular weight (Mw) and number average molecular weight (Mn) (in terms of polystyrene) by a gel permeation chromatograph. The results are shown in Table 1.

### Polymerization Examples 2 to 11

The monomer shown in Table 1 used in an equimolar amount was polymerized in the same manner as in Polymerization Example 1. Furthermore, the yield as well as the endo/exo ratio of the residual monomer in the reprecipitation filtrate were analyzed, and the endo/exo introduction ratio in the polymer was calculated. The molecular weight was measured in the same manner. The results are shown together in Table 1.

### Polymerization Example 12

Polymerization was performed in the same manner as in Polymerization Example 1 except for changing the monomer to 1,190 g of M-1 (83/17) and 75 g of NB. The yield was 98%. The remaining monomers in the reprecipitation filtrate were measured by gas chromatography, as a result, the residual NB was not contained. The introduction ratio of M-1/NB in the produced polymer was 90/10. The endo/exo ratio of the residual M-1 was 98/2. The endo/exo introduction ratio in the polymer was calculated. The molecular weight was also measured in the same manner. The results are shown together in Table 1.

### Polymerization Example 13

Polymerization was performed in the same manner as in Polymerization Example 12 except for changing M-1 to an equimolar amount of M-2 (83/17). The yield as well as the endo/exo ratio of the remaining monomer in the reprecipitation filtrate were analyzed, and the endo/exo introduction ratio in the polymer was calculated. The molecular weight was also measured in the same manner. The results are shown together in Table 1.

The structural formulae of P1 to P6 synthesized above are shown below. Polymers using M1 to M4 as a raw material are P1 to P4, respectively, and polymers using M1 and M2 together with NB as raw materials are P5 and P6, respectively. In Table 1, the polymer having the same structure but differing in the endo/exo ratio in the side chain is denoted like P1 (82/18). The numerical value at the top right of the parenthesis in P5 and P6 below indicates the copolymerization ratio.

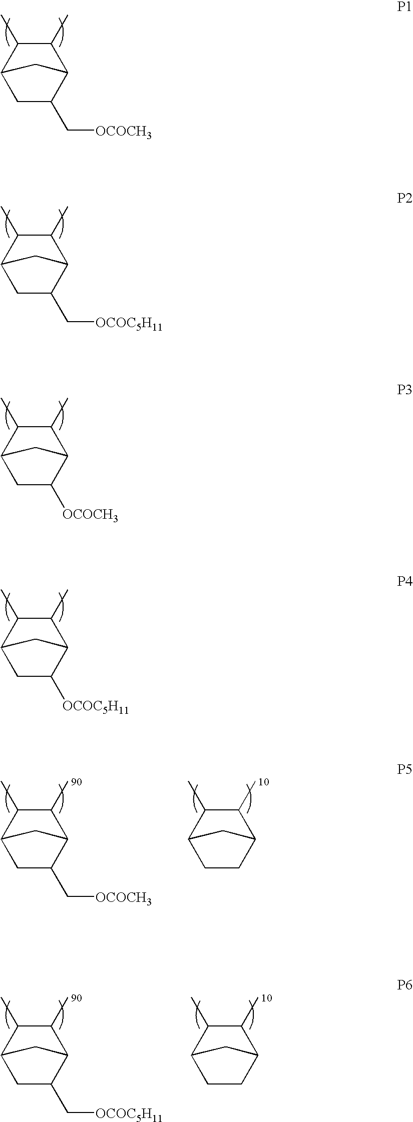

### Polymerization Example 14

NBC₆H₁₃ (713 g) and 166 g of M-1 (83/17) were charged into a reaction vessel, and then, 152 mg of palladium acetyl acetonate (produced by Tokyo Kasei Kogyo Co., Ltd.) dissolved in 10 mL of toluene, 150 mg of tricyclohexylphosphine (produced by Strem Chemicals, Inc.), and 805 mg of dimethylanilinium tetrakispentafluorophenyl borate (produced by Strem Chemicals, Inc.) dissolved in 10 mL of methylene chloride were charged into the reaction vessel. Furthermore, 3.5 L of toluene was added. The contents were stirred at 300 rpm and heating was started. The contents were stirred at an internal temperature of 90° C. for 6 hours. After dilution with 14 L of toluene, the obtained solution was added dropwise to 40 L of methanol to precipitate a polymer. The precipitate was collected and washed with methanol. The obtained white solid was vacuum-dried at 110° C. for 6 hours to obtain 871 g (yield: 99%) of P7. The ¹HNMR thereof was measured and from comparison of integration values for the methylene peak of the M-1 unit at 3.5 to 4.5 ppm and the remaining peaks at 0.5 to 3.0 ppm, the ratio between the unit attributable to NBC₆H₁₃ and the unit attributable to M-1 was found to be 79/21. The measurement results of the molecular weight are shown in Table 1.

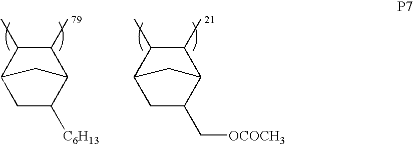

### Polymerization Example 15

NBCO₂C₄H₉ (421 g) and 360 g of M-1 (83/17) were charged into a reaction vessel, and then, 187 mg of palladium acetyl acetonate (produced by Tokyo Kasei Kogyo Co., Ltd.) dissolved in 10 mL of toluene, 195 mg of tricyclohexylphosphine (produced by Strem Chemicals, Inc.), and 994 mg of dimethylanilinium tetrakispentafluorophenyl borate (produced by Strem Chemicals, Inc.) dissolved in 10 mL of methylene chloride were charged into the reaction vessel. The contents were stirred at 300 rpm and heating was started. The contents were stirred at an internal temperature of 90° C. for 6 hours. Here, 3 L in total of toluene was added with the increase in the viscosity of the reaction solution, which was brought about as the reaction proceeded. After dilution with 10 L of toluene, 40 L of methanol was added dropwise over 3 hours to precipitate a polymer. The precipitate was collected and washed with methanol. The obtained white solid was vacuum-dried at 110° C. for 6 hours to obtain 586 g (yield: 75%) of P8. The ¹³CNMR thereof was measured and from comparison of integration values for the carbonyl carbons of butyl ester and acetyl, the ratio between the unit attributable to NBCO₂C₄H₉ and the unit attributable to M-1 in P8 was found to be 35/65. The measurement results of the molecular weight are shown in Table 1.

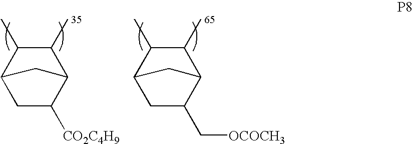

### Polymerization Example 16

M-1 (83/17) (510 g) was charged into a reaction vessel, and then, 187 mg of palladium acetyl acetonate (produced by Tokyo Kasei Kogyo Co., Ltd.) dissolved in 20 mL of toluene, 195 mg of tricyclohexylphosphine (produced by Strem Chemicals, Inc.), and 994 mg of dimethylanilinium tetrakispentafluorophenyl borate (produced by Strem Chemicals, Inc.) dissolved in 20 mL of methylene chloride were charged into the reaction vessel. Furthermore, 0.5 L of toluene was added. The contents were stirred at 300 rpm and heating was started. After the passing of 1 hour at an internal temperature of 90° C., 140 g of NBCO₂C₂H₄OH was added dropwise over 3 hours. Here, 2.0 L in total of toluene was appropriately added with the progress of the reaction. After the temperature reached 90° C., the contents were stirred for 6 hours. Subsequently, 4 L of toluene was added, and 8 L of methanol was added dropwise over 3 hours to precipitate Polymer P9. The precipitate was collected and washed with methanol. The obtained white solid was vacuum-dried at 110° C. for 6 hours to obtain 455 g (yield: 70%) of P9. The ¹³CNMR thereof was measured and from comparison of integration values for the carbonyl carbons of hydroxyethyl ester and acetyl, the ratio between the unit attributable to NBCO₂C₂H₄OH and the unit attributable to M-1 in P9 was found to be 20/80. The measurement results of the molecular weight are shown in Table 1.

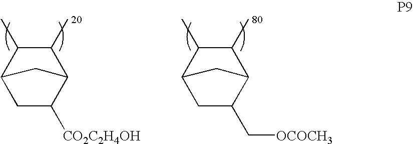

### Polymerization Example 17

P10 (yield: 67%) was obtained in the same manner as in Polymerization Example 16 except for using an equimolar amount of NBCO₂C₄H₉ in place of M-1. The sample was dissolved in tetrachloroethane-d2, and the ¹³CNMR was measured at 120° C. From comparison of integration values for the carbons of hydroxyethyl ester and butyl ester, the ratio between the unit attributable to NBCO₂C₂H₄OH and the unit attributable to NBCO₂C₄H₉ in P10 was found to be 17/83. The measurement results of the molecular weight are shown in Table 1.

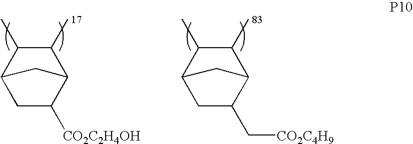

TABLE 1

| | | Endo Ratio of Raw | | | | | | |
|---|---|---|---|---|---|---|---|---|
| Polymerization | | Material Monomer | Yield of | Endo Ratio of | Endo Ratio of | Produced | | |
| Example | Raw Material Monomer | [%] | Polymer [%] | Filtrate [%] | Polymer [%} | Polymer | Mw | Mn |
| 1 | M1 (83/17) | 83 | 95 | 98 | 82 | P1 (82/18) | 350400 | 105600 |
| 2 | M1 (58/42) | 58 | 97 | 99 | 57 | P1 (57/43) | 345600 | 100400 |
| 3 | M1 (49/51) | 49 | 97 | 99 | 47 | P1 (48/52) | 300500 | 107800 |
| 4 | M1 (3/97) | 3 | 99 | 100 | 2 | P1 (3/97) | 723000 | 234000 |
| 5 | M2 (83/17) | 83 | 93 | 100 | 82 | P2 (82/18) | 334500 | 110400 |
| 6 | M2 (53/47) | 53 | 95 | 99 | 51 | P2 (51/49) | 356700 | 102300 |
| 7 | M2 (49/51) | 49 | 95 | 100 | 46 | P2 (46/54) | 314000 | 101000 |
| 8 | M3 (78/22) | 78 | 82 | 80 | 78 | P3 (78/22) | 243500 | 73200 |
| 9 | M3 (55/45) | 55 | 83 | 62 | 54 | P3 (54/46) | 267800 | 82000 |
| 10 | M4 (78/22) | 78 | 80 | 79 | 78 | P4 (78/22) | 223400 | 74500 |
| 11 | M4 (56/44) | 56 | 83 | 60 | 55 | P4 (55/45) | 245000 | 71000 |
| 12 | M1 (83/17)/NB | 83 | 98 | 98 | 83 | P5 (83/17) | 402300 | 124500 |
| 13 | M2 (83/17)/NB | 83 | 98 | 98 | 83 | P6 (83/17) | 413400 | 134000 |
| 14 | M1 (83/17)/NBC₆H₁₃ | 83/80 | 99 | not measured | not measured | P7 | 533000 | 184500 |
| 15 | M1 (83/17)/NBCO₂C₄H₉ | 83/45 | 75 | not measured | not measured | P8 | 324500 | 112300 |
| 16 | M1 (83/17)/NBCO₂C₂H₄OH | 83/45 | 70 | not measured | not measured | P9 | 245600 | 84500 |
| 17 | NBCO₂C₄H₉/NBCO₂C₂H₄OH | 45/45 | 67 | not measured | not measured | P10 | 234500 | 74600 |

### Examples 1 to 5 and Comparative Example 1

Methylene chloride (9,100 g), 1,080 g of methanol and 10 g of a 28% sodium methoxide and methanol solution (produced by Wako Pure Chemical Industries, Ltd.) were mixed, and 1,000 g of Polymer P1 (82/18) was added thereto, followed by stirring at room temperature. After 5 minutes, 40 minutes, 50 minutes, 80 minutes, 130 minutes and 200 minutes, about 1,500 g of the dope was sampled each time. The dope sampled was reprecipitated in a mixed solvent of 100 mL of acetic acid and 5 L of methanol. The obtained white solid was suction-filtered and vacuum-dried at 120° C. for 4 hours. The molecular weight of the polymer in which a hydroxyl group was introduced in this way was decreased from the molecular weight of the original polymer by the elimination of the acyl moiety. This reveals that the main chain was not broken and only the solvolysis reaction of the side chain, that is, the acyl group, was allowed to proceed. In other words, the total endo/exo ratio of the acyl group and the hydroxyl group was not varied.

Out of the polymer having introduced thereinto a hydroxyl group, a 1-g portion was dissolved in 10 mL of methylene chloride. Thereto, 10 mL of pyridine and 10 mL of benzoyl chloride were added. The amount of benzoyl chloride is an excess amount for the total amount of the acyl group and hydroxyl group in the polymer and therefore, the hydroxyl groups all are benzoylated. This solution was refluxed for 1 hour. The refluxed product was reprecipitated and then vacuum-dried at 120° C. for 4 hours. The obtained polymer was dissolved in methylene chloride-d2, and the ¹HNMR was measured. The ratio at which the hydroxyl group was replaced by benzoyl was determined from the integration ratio between the peak of the phenyl group in the vicinity of 7 ppm and the methylene peak at 3.2 to 4.7 ppm. This ratio corresponds to the ratio of original hydroxyl groups and therefore, indicates the hydroxyl group content of the original polymer. The results are shown in Examples 1 to 5 and Comparative Example 1 of Table 2. The results of the molecular weight are also shown in Table 2.

The polymer obtained above was dissolved in methylene chloride/methanol/butanol/water (at a weight ratio of 83/16/0.6/0.4) to give a solid material concentration of 22%. This solution was filtered under pressure and the obtained dope was cast and film-formed on an A3-size SUS plate set to −5° C. or −10° C. by using an applicator (clearance: 800 μm). The film was left standing for 10 seconds and then subjected to a strippability test. The kind of polymer, the temperature of SUS plate and the result of strippability are shown in Examples 1 to 5 of Table 2. Incidentally, the polymer having a hydroxyl group content of 75% was insoluble and could not be evaluated (Comparative Example 1).

### Examples 6 to 8 and Comparative Example 2

Using Polymer P1 (57/43), polymers differing in the hydroxyl group content were synthesized by adjusting the reaction time. The results of the molecular weight are shown in Table 2. The hydroxyl group-introduction ratio was calculated by performing benzoylation in the same manner as above. The strippability test was also performed in the same manner as above. The results are shown in Examples 6 to 8 of Table 2. Incidentally, the polymer having a hydroxyl group content of 72% was insoluble and could not be evaluated (Comparative Example 2).

### Examples 9 to 20

Using the polymers shown in Table 2, polymers differing in the hydroxyl group content were synthesized in the same manner as above. The hydroxyl group-introduction ratio was calculated by performing benzoylation in the same manner as above. The strippability test was also performed in the same manner as above. The results are shown in Examples 9 to 20 of Table 2. The results of the molecular weight are shown in Table 2.

### Comparative Examples 3 to 13

The dopes were produced in the same manner as above without hydrolyzing the polymers synthesized in Polymerization Examples, and the strippability test was performed. The films formed all had no self-supporting property and allowed the remaining of an unstripped film. The results are shown in Comparative Examples 3 to 13 of Table 2. The results of the molecular weight are shown in Table 2.

### Comparative Example 14

Methylene chloride (4,550 g), 540 g of methanol and 50 g of a 28% sodium methoxide and methanol solution (produced by Wako Pure Chemical Industries, Ltd.) were mixed, and 500 g of Polymer P7 was added thereto, followed by stirring at room temperature for 12 hours. The resulting mixture was reprecipitated in a mixed solvent of 50 mL of acetic acid and 2.5 L of methanol. The obtained white solid was suction-filtered and vacuum-dried at 120° C. for 4 hours. The measurement results of the molecular weight are shown in Table 2.

This polymer having introduced thereinto a hydroxyl group was benzoylated in the same manner as above. The ratio at which the hydroxyl group was replaced by benzoyl was determined in the same manner as above, and the hydroxy group content of the original polymer was calculated and found to be 100%. Also, in the ¹HNMR measurement, the acetyl group was not observed. This reveals that all acetyl groups were converted into a hydroxyl group. That is, the hydroxyl group-containing unit occupies 21% of all units.

Using this polymer having introduced thereinto a hydroxyl group, a dope was produced in the same manner as above, but the dope became white turbid and was not transparent. The dope was film-formed, as a result, the film was whitened and could not be evaluated.

### Comparative Example 15

Synthesis was performed in the same manner as in Synthesis Example 98 of JP-T-2006-518779 by using 532 g of M-1 (83/17) and 146 g of NBCO₂C₂H₄OH to obtain 285 g (yield: 42%) of P11. The ¹³CNMR was measured and from comparison of integration values for the carbonyl carbons of hydroxyethyl ester and acetyl, the ratio between the unit attributable to NBCO₂C₂H₄OH and the unit attributable to M-1 in P11 was found to be 20/80. The measurement results of the molecular weight are shown in Table 2.

Using this polymer, a dope was produced in the same manner as above, and the strippability test was performed. The film formed was extremely weak in the self-supporting property and could not be stripped at all. The results are shown in Table 2.

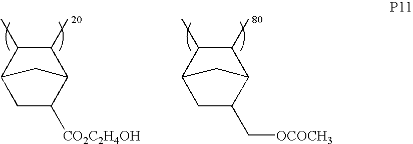

### Comparative Example 16

Synthesis was performed in the same manner as in Example 1 of JP-A-2007-131704 by using M-1 (83/17), norbornene methanol (produced by Aldrich) and NB to obtain P12 (yield: 57%). The ratio of the acetyl group to the hydroxyl group was determined by performing benzoylation in the same manner as above, as a result, the ratio between the unit attributable to M-1 (83/17) and the unit attributable to norbornene methanol in P12 was found to be 90/10. Furthermore, from the integration value for the methylene peak at 3.2 to 4.7 ppm and the integration value for the remaining protons at 0.3 to 3.0 ppm in ¹HNMR, the ratio among the unit attributable to M-1 (83/17), the unit attributable to norbornene methanol in P12 and the unit attributable to NB was found to be 60/7/33. The measurement results of the molecular weight are shown in Table 2.

Using this polymer, a dope was produced in the same manner as above, and the strippability test was performed. The film formed was weak in the self-supporting property and could be hardly stripped. The results are shown in Table 2.

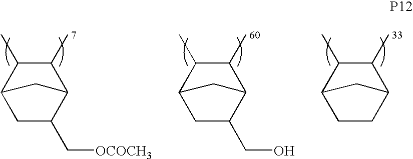

### Comparative Example 17

Synthesis was performed in the same manner as in Example 13 of JP-A-2006-16606 by using ethylidene norbornene (produced by Aldrich) and NBOH (78/22) to obtain P13. The measurement results of the copolymerization ratio and molecular weight were the same as those in Example 13 of JP-A-2006-16606. The results are shown in Table 2.

Using this polymer having introduced thereinto a hydroxyl group, a dope was produced in the same manner as above, but the dope became white turbid and was not transparent. The dope was film-formed, as a result, the film was whitened and could not be evaluated.

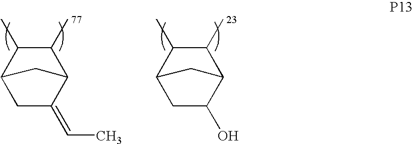

### Example 21

Methylene chloride (4,550 g), 540 g of methanol and 5 g of a 28% sodium methoxide and methanol solution (produced by Wako Pure Chemical Industries, Ltd.) were mixed, and 500 g of Polymer P8 was added thereto, followed by stirring at room temperature for 60 minutes. This mixture was reprecipitated in a mixed solvent of 50 mL of acetic acid and 2.5 L of methanol. The obtained white solid was suction-filtered and vacuum-dried at 120° C. for 4 hours. The ¹HNMR was measured, as a result, it was confirmed that the butyl ester group moiety was remained unreacted and only the acetyl group moiety was methanolyzed. The measurement results of the molecular weight are shown in Table 2.

This polymer having introduced thereinto a hydroxyl group was benzoylated in the same manner as above. The obtained polymer was dissolved in methylene chloride-d2, and the ¹HNMR was measured. From comparison of methylene peaks (3.4 to 4.8 ppm) of three units with the peak of benzoyl (in the vicinity of 7 ppm), it could be determined that the unit having a benzoyl moiety occupies 20 mol % of the entirety. This ratio corresponds to the ratio of original hydroxyl groups and therefore, indicates the hydroxyl group content of the original polymer.

The production of a dope and the strippability test were performed in the same manner as above. The results are shown in Example 21 of Table 2.

### Examples 22 and 23

Using Polymers P9 and P10 synthesized in Polymerization Examples 16 and 17, dopes were produced in the same manner and the strippability test was performed. The results are shown in Examples 22 and 23 of Table 2.

In Table 2, the hydroxyl group content indicates the ratio of the hydroxyl group-containing unit occupying in the total of the hydroxyl group-containing unit and the ester group or acyl group-containing unit in the polymer. This ratio corresponds to y/(x+y) in formulae (1A) and (1B). The substituent other than a hydroxyl group indicates an ester, an acyl or both as the copolymerization components. This substituent corresponds to A in formula (1A).

TABLE 2

| | Raw Material | Hydroxyl Group | Substituent Other Than | | | | Strippability | Strippability |
|---|---|---|---|---|---|---|---|---|
| | Polymer | Content | Hydroxyl Group | Mw | Mn | Solubility | (−5° C.) | (−10° C.) |
| Example 1 | P1 (82/18) | 3% | OCOCH₃ | 347700 | 104800 | ⊚ | ◯ | ◯ |
| Example 2 | P1 (82/18) | 18% | OCOCH₃ | 334400 | 100800 | ⊚ | ⊚ | ⊚ |
| Example 3 | P1 (82/18) | 26% | OCOCH₃ | 327400 | 98700 | ⊚ | ⊚ | ⊚ |
| Example 4 | P1 (82/18) | 35% | OCOCH₃ | 319400 | 96300 | ⊚ | ⊚ | ⊚ |
| Example 5 | P1 (82/18) | 50% | OCOCH₃ | 306100 | 92200 | ◯ | ⊚ | ⊚ |
| Example 6 | P1 (57/43) | 5% | OCOCH₃ | 341200 | 99100 | ⊚ | ◯ | ⊚ |
| Example 7 | P1 (57/43) | 24% | OCOCH₃ | 324600 | 94300 | ⊚ | ⊚ | ⊚ |
| Example 8 | P1 (57/43) | 47% | OCOCH₃ | 304500 | 88500 | ◯ | ⊚ | ⊚ |
| Example 9 | P1 (48/52) | 22% | OCOCH₃ | 283800 | 101800 | ⊚ | ◯ | ◯ |
| Example 10 | P1 (3/97) | 25% | OCOCH₃ | 677300 | 219200 | ⊚ | ◯ | ◯ |
| Example 11 | P2 (82/18) | 17% | OCOC₅H₁₁ | 309400 | 102100 | ⊚ | ⊚ | ⊚ |
| Example 12 | P2 (82/18) | 29% | OCOC₅H₁₁ | 291700 | 96300 | ⊚ | ⊚ | ⊚ |
| Example 13 | P2 (51/49) | 24% | OCOC₅H₁₁ | 318900 | 91500 | ⊚ | ⊚ | ⊚ |
| Example 14 | P2 (46/54) | 22% | OCOC₅H₁₁ | 283500 | 91200 | ⊚ | ◯ | ◯ |
| Example 15 | P3 (78/22) | 17% | OCOCH₃ | 232100 | 71000 | ⊚ | ⊚ | ⊚ |
| Example 16 | P3 (78/22) | 32% | OCOCH₃ | 222000 | 70200 | ⊚ | ⊚ | ⊚ |
| Example 17 | P3 (54/46) | 23% | OCOCH₃ | 250800 | 76800 | ⊚ | ⊚ | ⊚ |
| Example 18 | P4 (78/22) | 26% | OCOC₅H₁₁ | 200200 | 70100 | ⊚ | ⊚ | ⊚ |
| Example 19 | P5 (83/17) | 24% | OCOCH₃ | 379300 | 117400 | ⊚ | ⊚ | ⊚ |
| Example 20 | P6 (83/17) | 28% | OCOC₅H₁₁ | 364600 | 118200 | ⊚ | ⊚ | ⊚ |
| Example 21 | P8 | 20% | OCOCH₃, CO₂C₄H₉ | 309000 | 106900 | ⊚ | ⊚ | ⊚ |
| Example 22 | P9 ** | 20% | OCOCH₃ | 245600 | 84500 | ⊚ | ⊚ | ⊚ |
| Example 23 | P10 ** | 17% | CO₂C₄H₉ | 234500 | 74600 | ⊚ | ⊚ | ⊚ |
| Comparative | P1 (82/18) | 75% | OCOCH₃ | 284000 | 85600 | X | — | — |
| Example 1 | | | | | | | | |
| Comparative | P1 (57/43) | 72% | OCOCH₃ | 282700 | 82100 | X | — | — |
| Example 2 | | | | | | | | |
| Comparative | P1 (82/18) | — | OCOCH₃ | 350400 | 105600 | ⊚ | X | X |
| Example 3 | | | | | | | | |
| Comparative | P1 (57/43) | — | OCOCH₃ | 345600 | 100400 | ⊚ | X | X |
| Example 4 | | | | | | | | |
| Comparative | P1 (48/52) | — | OCOCH₃ | 300500 | 107800 | ⊚ | X | X |
| Example 5 | | | | | | | | |
| Comparative | P2 (82/18) | — | OCOC₅H₁₁ | 334500 | 110400 | ⊚ | X | X |
| Example 6 | | | | | | | | |
| Comparative | P2 (51/49) | — | OCOC₅H₁₁ | 356700 | 102300 | ⊚ | X | X |
| Example 7 | | | | | | | | |
| Comparative | P2 (46/54) | — | OCOC₅H₁₁ | 314000 | 101000 | ⊚ | X | X |
| Example 8 | | | | | | | | |
| Comparative | P3 (78/22) | — | OCOCH₃ | 243500 | 73200 | ⊚ | X | X |
| Example 9 | | | | | | | | |
| Comparative | P3 (54/46) | — | OCOCH₃ | 267800 | 82000 | ⊚ | X | X |
| Example 10 | | | | | | | | |
| Comparative | P4 (78/22) | — | OCOC₅H₁₁ | 223400 | 74500 | ⊚ | X | X |
| Example 11 | | | | | | | | |
| Comparative | P5 (83/17) | — | OCOCH₃ | 402300 | 124500 | ⊚ | X | X |
| Example 12 | | | | | | | | |
| Comparative | P6 (83/17) | — | OCOCH₃ | 413400 | 134000 | ⊚ | X | X |
| Example 13 | | | | | | | | |
| Comparative | P7 | 21% | C₆H₁₃ | 506200 | 175200 | X | — | — |
| Example 14 | | | | | | | | |
| Comparative | P11 ** | 20% | OCOCH₃ | 14200 | 7100 | ⊚ | X | X |
| Example 15 | | | | | | | | |
| Comparative | P12 ** | 10% | OCOCH₃ | 172000 | 69000 | ⊚ | X | X |
| Example 16 | | | | | | | | |
| Comparative | P13 ** | 10% | CHCH₃ | 266000 | 202000 | X | — | — |
| Example 17 | | | | | | | | |

** In Examples 22 and 23 and Comparative Examples 15, 16 and 17, the raw material polymer was directly used.
Rating of Solubility:
Completely dissolved and the dope is transparent (⊚)
Dissolved but the dope is not completely transparent (◯)
Not dissolved (X)
Rating of Strippability:
No unstripped film (⊚)
Unstripped film is produced but in a percentage of 1% or less of the film area (◯)
Unstripped film is present (X)

In this way, the polymer having a hydroxyl group content falling in the range of the present invention exhibits good solubility and good strippability at cooling. In particular, when the total endo form content of the hydroxyl group and acyl group is 50% or more, the polymer exhibits good strippability even at a relatively high temperature of −5° C. In the case where the amount of the hydroxyl group is excessively large or the substituent other than a hydroxyl group is not an ester or an acyl, the polymer exhibits bad solubility in a solvent and cannot be film-formed. In the case of not having a hydroxyl group, the film cannot be stripped. Furthermore, when the molecular weight is out of the range of the present invention, film strippability is bad.

### Example 24

### High-Seed Casting Film Formation)

Scale-up production of the polymer obtained in Example 2 is performed. A polymer was prepared according to a known method by adding 26.8 parts by weight of the polymer obtained in Example 2, 2.1 parts by weight of triphenyl phosphate (TPP), 1.1 parts by weight of biphenyl diphenyl phosphate (BDP), and 0.13 parts by weight of Irganox 1010 (IRG1010, produced by Ciba-Geigy) to a mixed solvent of methylene chloride/methanol/butanol/water (weight ratio: 83/16/0.6/0.4). The solid material concentration was 23 wt %. Incidentally, in the present invention, the parts by weight of the solute means the weight ratio to the mixed solvent which was taken as 100 parts by weight.

The film formation was performed using the film-forming line 10 shown in Table 1. A coat hanger-type die was used as the casting die 23. Also, the rotating drum 22 as the support was mirror-finished to have a surface roughness of 0.04 S. The surface temperature of the rotating drum 22 was kept at −5° C. by supplying a coolant from a coolant supply device 45. Also, in order to create a circumferential velocity ratio (V1/V0) of 1.1, the circumferential velocity V0 (casting speed) of the rotating drum was set to 100 m/min, and the circumferential velocity V1 of the stripping roller 25 was set to 110 m/min. The clearance C1 between the rotating drum 22 and the stripping roller 25 was set to 5 mm. Furthermore, a first gas 28 at a flow velocity of 1 m/s and a temperature of 35° C., a second gas 30 at a flow velocity of 5 m/s and a temperature of 80° C., and third gases 48 and 49 at a flow velocity of 5 m/s and a temperature of 25° C. were blown.

After setting to the conditions above, a dope 12 at 30° C. was cast on the rotating drum 22 to give a film 26 having a dry thickness of 80 μm. At the stripping, the gel film 24 was observed with an eye, as a result, an unstripped film and rise of the stripping position were not recognized at all. This film 26 was dried at 135° C. for 3 minutes by a tenter dryer 62 and further dried in a drying zone 61 at 135° C. for 10 minutes and then cooled in a cooling chamber 64 at 80° C. for 1 minute. Finally, the film was taken up by a take-up machine 65. The surface of the film 26 was observed and found to have remarkably good smoothness. This film formation was continuously performed for 48 hours, but an unstripped film was not recognized at all.

### Examples 25 to 27

### High-Speed Casting Film Formation

Films were produced in the same manner as in Example 24 by performing scale-up production of polymers obtained in Examples 3, 12 and 15. In all cases, the film had good smoothness and high-speed film formation could be performed without causing an unstripped film. The continuous film formation was performed for 48 hours, 24 hours and 24 hours.

### Examples 28 to 31

### Stretching

The films obtained in Examples 24 to 27 each was 20% stretched in a fixed-end condition at a temperature of 220° C. by using an automatic stretching machine manufactured by Imoto Seisakusho to obtain a stretched film. The retardation at a wavelength of 590 nm was measured. The thickness of the film was measured at 3 points in an arbitrary portion by a digital micrometer, and the average value d thereof was taken. Based on this, Re and Rth in terms of a film thickness of 80 μm were determined according to the following mathematical formulae. The results are shown in Table 3.

Re=measured Re/d×80

Rth=measured Rth/d×80

TABLE 3

| | Re [nm] | Rth [nm] |
|---|---|---|
| Example 28 | 72 | 203 |
| Example 29 | 84 | 225 |
| Example 30 | 69 | 240 |
| Example 31 | 64 | 120 |

### Example 32

### Production and Evaluation of Polarizing Plate

Films F1 to F3 produced in Examples 28 to 30 and Fuji TAC (produced by Fujifilm Corp.) each was dipped in an aqueous 1.5N sodium hydroxide solution at 60° C. for 2 minutes, further dipped in an aqueous 0.1N sulfuric acid solution for 30 seconds, and then passed through a water washing bath, thereby effecting a saponification treatment.

According to Example 1 of JP-A-2001-141926, a 75 μm-thick polyvinyl alcohol “9X75RS” {produced by Kuraray Co., Ltd.} was stretched in the longitudinal direction by creating a difference in the circumferential velocity between two pairs of nip rolls to obtain a polarizing film.

The thus-obtained polarizing film and one of saponified F1 to F3 were stacked together using an aqueous 3 mass % PVA “PVA-117H” (produced by Kurary Co., Ltd.) solution as an adhesive in a layer construction of “one of saponified F1 to F3/polarizing film/saponified Fuji TAC” by arranging the longitudinal direction of the film at 45° to produce Polarizing Plates Pol-1 to Pol-3. Good lamination together was obtained, and warpage or the like after drying was not observed.

### Example 33

### Production and Evaluation of Liquid Crystal Display

Out of two pairs of polarizing plates disposed to sandwich a liquid crystal layer in a 26-inch or 40-inch liquid crystal display (manufactured by Sharp Corp.) using a VA-type liquid crystal cell, the polarizing plate of one surface on the viewer side was stripped, and one of Polarizing Plates Pol-1 to Pol-3 was stacked instead by using a pressure-sensitive adhesive. The transmission axis of the polarizing plate on the viewer side and the transmission axis of the polarizing plate on the backlight side were arranged to cross at right angles, thereby producing a liquid crystal display. The film of the present invention was disposed on the viewer side. The color unevenness of the obtained liquid crystal device was observed. The liquid crystal display having incorporated thereinto one of Polarizing Plates Pol-1 to Pol-3 of the present invention was very excellent without causing color unevenness.

A cyclic olefin polymer according to an exemplary embodiment of the present invention and the optical material using the polymer are useful for various functional films such as polarizing plate protective film, phase difference film, viewing angle-enlarging film and antireflection film used for a plasma display. Also, a cyclic olefin polymer according to an exemplary embodiment of the present invention and the optical material using the polymer can be produced at a low cost and are endowed with excellent optical characteristics and therefore, useful for a polarizing plate and a liquid crystal display.

What is claimed is:

1. A cyclic olefin polymer comprising a repeating unit represented by formula (1A) and a repeating unit represented by the formula (1B): 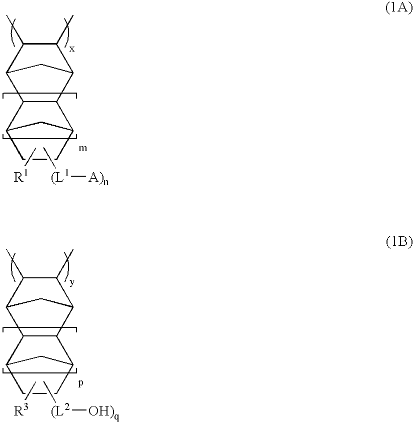
wherein R¹ and R³ each independently represents a substituent, L¹ and L² each independently represents a single bond or a divalent linking group, m and p each independently represents an integer of 0 or 1, and n and q each independently represents an integer of 1 to 4; and A represents COOR² or OCOR², and R² represents a linear alkyl group having a carbon number of 1 to 10,
wherein the cyclic olefin polymer has a copolymerization ratio of x and y satisfying 0.03≦y/(x+y)≦0.50, a number average molecular weight of from 70,000 to 300,000, and a weight average molecular weight of from 200,000 to 700,000.

2. The cyclic olefin polymer according to claim 1, wherein A is OCOR².

3. The cyclic olefin polymer according to claim 1, further comprising a repeating unit represented by formula (2): 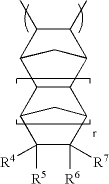
wherein R⁴, R⁵, R¹ and R⁷ each independently represents a hydrogen atom, a halogen atom, an alkyl group having a carbon number of 1 to 10, an aryl group having a carbon number of 6 to 20, an alkoxy group having a carbon number of 1 to 10, an acyl group having a carbon number of 1 to 10, or a carboxyl group, and r represents an integer of 0 or 1.

4. The cyclic olefin polymer according to claim 2, wherein each of n and q is 1, and a total endo ratio of substituents L¹-A and L²-OH is from 50 to 100%.

5. An optical material formed from a cyclic olefin polymer according to claim 1.

6. The optical material according to claim 5, wherein the optical material is a thin-layer, a film or a sheet.

7. The optical material according to claim 6, which satisfying conditions:
0≦Re≦100 nm
0≦Rth≦400 nm
wherein Re and Rth represent an in-plane retardation and a retardation in a thickness direction at a wavelength of 590 nm, respectively.

8. A polarizing plate comprising: a polarizer and two protective films disposed on the respective sides of the polarizer, wherein at least one of the two protective films is an optical material according to claim 7.

9. A liquid crystal display comprising a polarizing plate according to claim 8.
